(19) United States
(12) Patent Application Publication
(10) Pub. No.: US 2008/0052373 A1
(43) Pub. Date: Feb. 28, 2008

(54) SYSTEMS AND METHODS FOR A COMMUNITY-BASED USER INTERFACE

(75) Inventor: Michael Pousti, San Diego, CA (US)

Correspondence Address: BAKER & MCKENZIE LLP;PATENT DEPARTMENT, 2001 ROSS AVENUE, SUITE 2300, DALLAS, TX, 75201, US

(73) Assignee: SMS.AC, San Diego, CA (US)

(21) Appl. No.: 11/743,040

(22) Filed: May 1, 2007

Related U.S. Application Data
(63) Continuation-in-part of application No. 11/516,921, filed on Sep. 6, 2006.
(60) Provisional application No. 60/796,651, filed on May 1, 2006.

(51) Int. Cl. G06F 15/16

(52) U.S. Cl. 709/217; 709/203

(57) ABSTRACT

Systems and methods for providing a desktop user interface for accessing and using community-based contact management, communication tools, websites and application pods in a convenient and integrated fashion, in an always-on mode. The desktop user interface resides on the user's desktop as an application and provides access to the aforementioned community-based services in a convenient, integrated manner without the need to open a browser in order to access the community-based services.

### RELATED APPLICATION INFORMATION

This Application claims the benefit under 35 U.S.C. 119(e) to U.S. Provisional Patent Application Ser. No. 60/796,651, filed May 1, 2006, entitled “Community-Based Desktop User Interface.” This Application claims the benefit as a Continuation-In-Part under 35 U.S.C. §120 to U.S. patent application Ser. No. 11/516,921, filed Sep. 6, 2006, entitled “Automated Billing and Distribution Platform for Application Providers.” Both of the above applications are incorporated herein for all purposes.

This Application is also related to commonly-owned U.S. patent application Ser. No. 11/446,973, filed Jun. 6, 2006, entitled “Billing Systems and Methods For Micro-Transactions,” which is incorporated by reference herein for all purposes.

### BACKGROUND INFORMATION

1. Field

The present invention relates to a social, or community-based online network, and more particularly to the ability to access community-based functions and services from the desktop.

2. Background

U.S. patent application Ser. No. 11/516,921 described a community-based online network cite that makes various applications, termed Pods, available as well as various services, such as contact list maintenance, messaging, chat, etc. As explained, a user can access a community platform associated with the cite using a browser in order to access the applications and service provided. Accessing the network in this manner is not unusual as computer and mobile device users use a multitude of applications and websites via a web browser on a frequent basis in order to communicate with others, share information, obtain information and use third-party applications for services and entertainment.

Unfortunately, the need to access such services through a browser can be limiting. For example, using a browser to access applications and services is often not as efficient as accessing applications and services on the user's computer “desktop,” i.e., applications stored on the user's actual computer. Further, alternating between desktop applications and browser applications can be cumbersome and inefficient. Navigating between multiple browser based applications can be even more cumbersome, often requiring the user to open multiple browsers.

For example, a typical user may have several address books friends, family and other contacts, thereby making coordinated management of, and communication between, all contacts difficult. In addition, the sharing of information is often difficult because the user must jump between different applications and/or websites to send or receive documents via the internet from contacts such as friends and family. For example, if a user desires to send photos to a group of friends, the user may first need to access one or more email applications to find the friends contact information in one or more address books, and then access a particular application, such as a photo application, or a file browser, to create or access the desired data file for the photo. The user then generates an email by accessing the different address books, attaches the photo data file, and sends the email to the group of friends.

In another example, a user may subscribe to an application service provided on a website, which is only accessed through the web. In such a case, when the user wants to use the application service, the user must initiate a web browser and sign in, if necessary, rather than easily access the application service just like any other application on the user's desktop.

Community-based services are becoming more and more popular. In other words, it is not enough to provide users with email, word processing, spread sheets, etc. Rather, many users want to be able to create content with such programs and share them with a group of friends, or “buddies,” quickly and easily. Unfortunately, today's online and desktop applications and services do not allow the type of easy integration between applications and community needed to provide such functionality.

### SUMMARY

Systems and methods for providing a desktop user interface for accessing and using community-based contact management, communication tools, websites and application pods in a convenient and integrated fashion, in an always-on mode.

In one aspect, the desktop user interface resides on the user's desktop as an application and provides access to the aforementioned community-based services in a convenient, integrated manner without the need to open a browser in order to access the community-based services.

The desktop user interface can be provided in an application window frame and can be handled on the user's desktop as an application, and can also maintain a presence in the user's toolbar. Unlike typical desktop applications, however, the desktop user interface application can always be connected to a community-based platform via the internet, integrate all user contacts for convenient communication, provide direct access to websites, provide convenient communication and information sharing tools, and provides direct access to third-party application pods that the user has purchased without requiring the downloading of software for each application pod, and allow pods to be undocked on the user's desktop.

In this manner, a user can conveniently, and from a single application, readily take advantage of the community-based tools and services provided through a community platform to directly access websites, aggregate and manage contacts, easily communicate with contacts via a variety of communication tools, easily share information with contacts, participate in the community via community tools and services, and manage, access and use application pods from the user's desktop.

A community-based platform linking applications to the desktop not only facilitates their access by the user but also enables real-time sharing of these applications by other community members.

These and other features, aspects, and embodiments of the invention are described below in the section entitled “Detailed Description.”

### BRIEF DESCRIPTION OF THE DRAWINGS

Features, aspects, and embodiments of the inventions are described in conjunction with the attached drawings, in which:

FIG. 1 is a block diagram that illustrates an exemplary computer system that can be configured to implement the systems and methods described herein;

FIG. 2 is a block diagram that illustrated a computer-based mobile community in accordance with one embodiment;

FIG. 3 is a block diagram that illustrates a more detailed view of the high-level system view of FIG. 2;

FIG. 4 is a flowchart illustrating an example method for distributing software via the mobile community architecture of FIG. 2;

FIGS. 5-8 are screenshots illustrating example windows that software developers may be presented to assist in registering a new pod with the mobile community architecture of FIG. 2;

FIG. 9 is a diagram illustrating an example pod that can be developed and registered using the process depicted in screenshots 5-8;

FIG. 10 is a diagram illustrating an example user profile page that can include pods, such as the pod of FIG. 9, and can be hosted by the mobile community architecture of FIG. 2;

FIG. 11 is a flowchart illustrating an example method for a user to add a pod to their profile page;

FIGS. 12 and 13 are flowcharts illustrating the operation of a pod and its associated pod application within the mobile community of FIG. 2;

FIG. 14 is a block diagram of a global mobile platform that can be included in the computer-based global mobile community of FIG. 3;

FIG. 15 is a flow chart illustrating an example method for instituting a complaint department within the mobile community of FIG. 2;

FIG. 16 is a flowchart illustrating an example method for regulating messages within the mobile community of FIG. 2;

FIG. 17 is a is a block diagram illustrating a computer-based mobile community platform in which a desktop application can be downloaded from the mobile community platform according to one embodiment; and

FIGS. 18-35 are screen shots illustrating the operation of the desktop application of FIG. 17.

### DETAILED DESCRIPTION

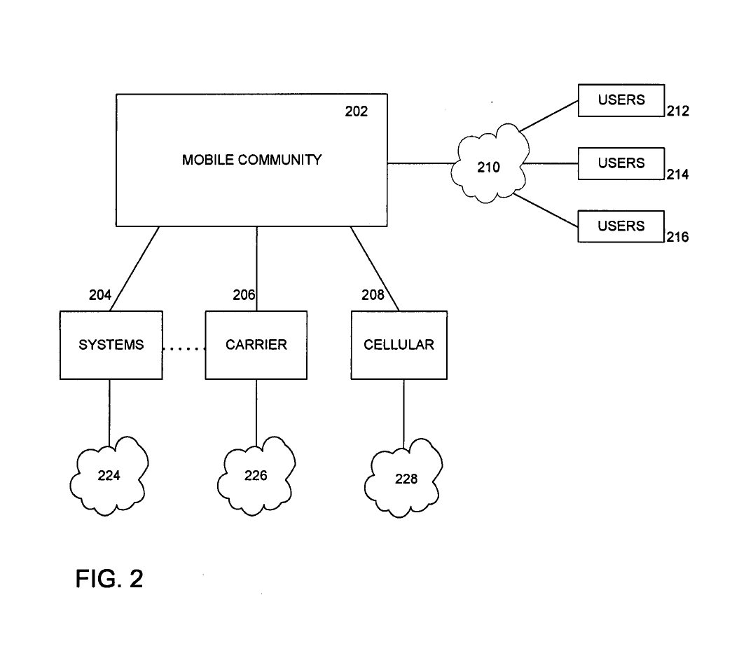

FIG. 2 depicts a block diagram of a computer-based mobile community 202. Users 212, 214, 216 can connect to the mobile community 202 via a network or similar communications channel 210. Via the connection, a user (e.g., 212) may create a profile page or “home page” that they can personalize. This profile page can include various files and content that the user wants to share with other members of the mobile community 202.

The profile page may include a hierarchy of pages, some of which are for public view and some of which have restrictions on viewing. For example, the mobile community 202 can be logically organized into neighborhoods such as “friends”, “family”, “workplace”, “dog owners”, etc. Users 212, 214, 216 can belong to these different neighborhoods and share different pages with the members of the different neighborhoods.

Additionally, this mobile community 202 connects with various wireless carrier systems 204, 206, 208, each of which has an associated community of mobile phone subscribers, 224, 226 and 228. Users 212, 214, 216 of the mobile community 202 are also subscribers of various wireless carriers. In this way, users 212, 214, 216 of the mobile community 202 not only have access through the computer-based platform 202 to other users' profile pages, they also have easy access to subscribers of the various wireless carrier systems 204, 206, 208.

A benefit of the architecture depicted in FIG. 2, is that the mobile community platform 202 has already contracted for services with the wireless carrier systems 204, 206, 208. As is known in the art, the wireless carrier systems 204, 206, 208 provide messaging and premium message functionality. Such messages are sent via the wireless carrier's infrastructure to mobile subscribers and, internal to the wireless carrier's infrastructure, generate a billing event according to a particular tariff rate. In practice, when the mobile community 202 sends a message via a wireless carrier system (e.g., 204), it is billing the recipient of the message using the existing billing system of that wireless carrier. The billing event is often a micro-transaction. Thus, a user (e.g., 212) of the mobile community may conduct transactions with a vendor within the mobile community 202 and be billed for those transactions via their wireless service account. The vendor in the transaction need only communicate with the mobile community 202 regarding the transaction and does not require any affiliation or agreement with any wireless carrier.

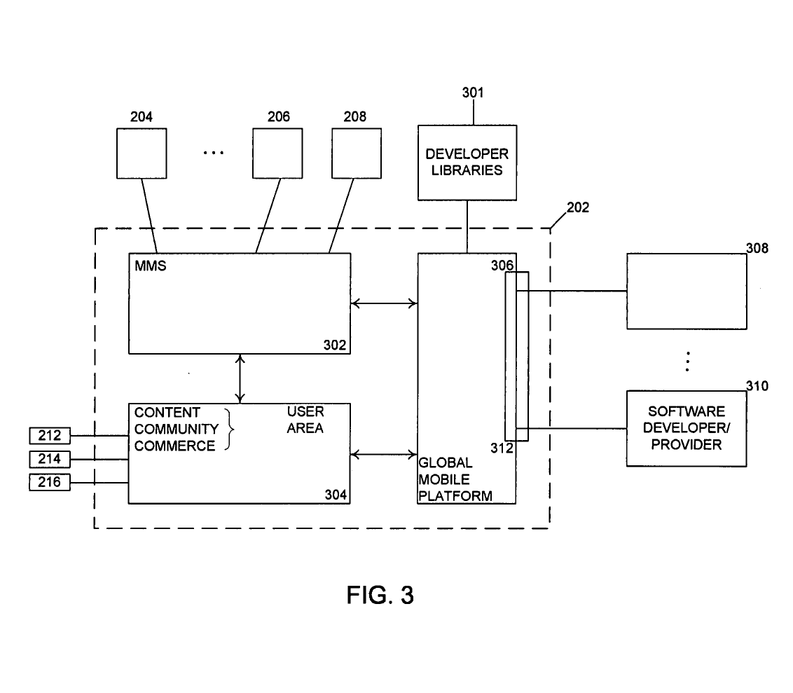

FIG. 3 depicts a more detailed view of the high-level system view of FIG. 2. In particular, the system of FIG. 3 can be used to conduct micro-transaction in which a wireless carrier's billing system is used by the mobile community 202 platform to automatically bill the user for each micro-transactions with a vendor/retailer, without the need for a negotiation or contract between the vendor and the wireless carrier. One example of this feature is that of software content distribution where software developers can offer software products to the users of the mobile community 202, while taking advantage of the billing arrangements already in place between the mobile community 202 and the wireless carriers 204, 206, 208. Of course, a software application may provide any other type of content or service to users of mobile community 202.

Some of the sub-components of the mobile community 202 are a global mobile platform 306, the user area 304 where the content, community and commerce functions are handled for the users, and a multimedia messaging system 302. The details of these different sub-components are more fully explained throughout the remainder of this detailed description.

As noted earlier, users 212, 214, 216 can visit the user area 304 to participate in an on-line community that includes various content and commerce opportunities. This is typically accomplished via a user's web browser that may be hosted on a laptop or desktop computer, or, in the alternative, even on the user's mobile device such as a PDA or mobile phone. Thus, the user area 304 includes a web server that communicates with users 212, 214, 216 and includes a data store of user information and other content. With these resources, the mobile community 202 is able to present to a user 212 a profile page (“home page”) that reflects content and information associated with, and desired by, that particular user. This content and information is not maintained on the local computer being used by the user 212 but, rather, is maintained and managed by the computer systems within the user area 304.

Although not explicitly depicted in FIG. 3, one of ordinary skill will recognize that there are numerous functionally equivalent techniques to create, manage, store and serve user information, user profiles, user content, software tools and other resources within the user area 304. Included in these techniques are methods to ensure security, data integrity, data availability and quality of service metrics.

The multimedia messaging system 302 includes applications for connecting with and communicating with the multiple different wireless carriers 204, 206, 208 that have been partnered with the platform of mobile community 202. The MMS 302 is configured to generate message requests in the appropriate format for each of the wireless carriers 204, 206, 208 including tariff information that determines the amount for which the recipient of the message will be charged. Upon receipt of the message request, the wireless carriers 204, 206, 208 will use the information in the request to generate an appropriate message to the intended recipient/subscriber of the wireless carrier and then bill the recipient/subscriber's wireless service account for the specified amount.

The MMS 302 communicates with the user area 304, such that users of the mobile community 202 can advantageously use the connectivity of the MMS 302 with the carriers in order to send messages to subscribers of any of the wireless carriers 204, 206, 208. The messages may be SMS messages, MMS messages, or other message formats that are subsequently developed. Some of these messages may have zero tariff and, therefore do not generate a bill (other than the underlying charges implemented by the wireless carrier) and others may have non-zero tariffs resulting in a billing event for the recipient.

The global mobile platform 306 provides a link between software developers/providers 308, 310 and the mobile community 202. In particular, using an interface 312 (described in more detail herein), a software provider 308, 310 may offer services and products to users 212, 214, 216. Advantageously for the software provider 308, 310, the global mobile platform 306 also provides automatic and instant connectivity to the MMS 302 and the wireless carriers 204, 206, 208. Accordingly, the software provider 308, 310 can interact with all users of the mobile community 202 whereby billable transactions with users 212, 214, 216 are automatically billed via the billing systems of the wireless carriers 204, 206, 208. Furthermore, and importantly, this capability is available to the software provider 308, 310 without requiring the software provider 308, 310 to negotiate or contract with any wireless carrier for billing arrangements, or to worry about how to communicate with a wireless carrier's systems and resources. The software provider seamlessly takes advantage of the unified set of connectivity and billing arrangements that exist between the mobile community 202 and the wireless carriers 204, 206, 208. Thus, in addition to the contractual arrangements and affiliations the mobile community 202 has in place with different carriers 204, 206, 208, the underlying technical and communications infrastructure is also in place to communicate with and interoperate with each of the different carriers 204, 206, 208. As a result, vendors and other members of the mobile community may interface with and operate with any of a variety of different carriers without difficulty.

While some software applications that are available to users 212, 214, 216 may be hosted in the user area 304, the global mobile platform 306, or elsewhere in the community 202, it is often the case that the software developer/provider 308, 310 will host their own software application at their own remote location. Accordingly, in the description that follows, even if remotely-hosted software is being discussed in a specific example, one of ordinary skill will readily appreciate that software application being hosted differently is also expressly contemplated.

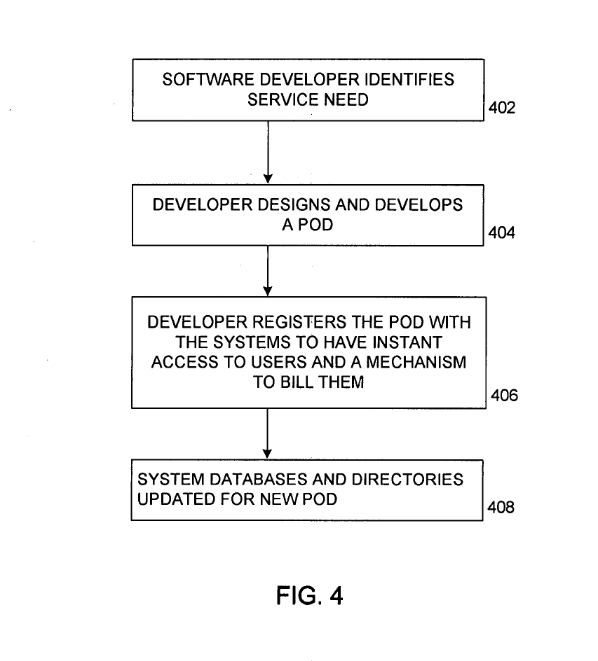

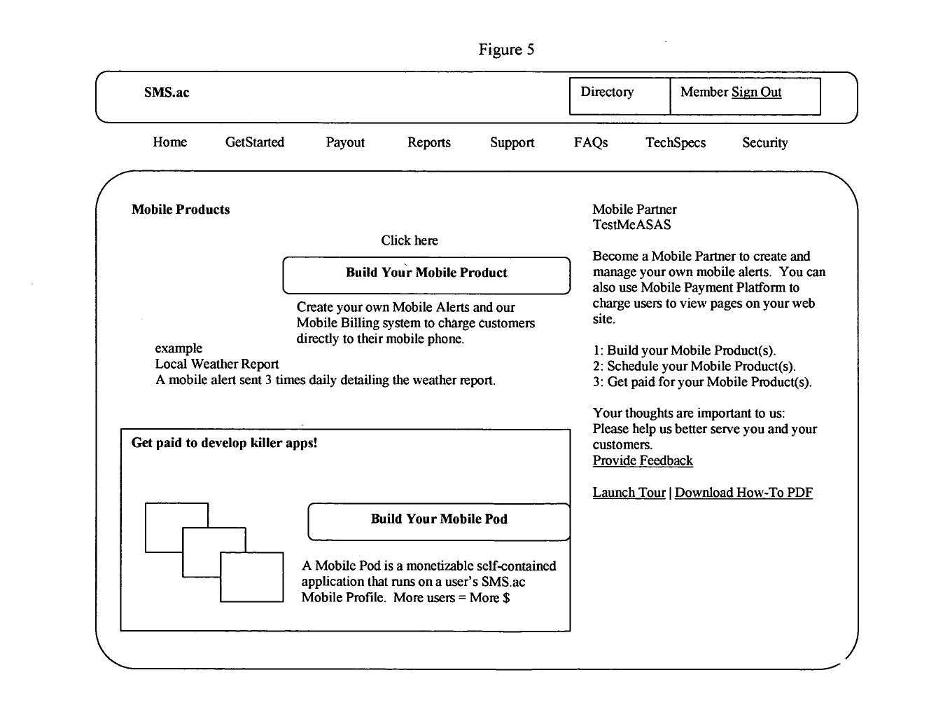

FIG. 4 depicts a flowchart of an exemplary method for distributing software via the mobile community architecture of FIG. 2. In a first step 402, a software developer identifies a marketplace need that is not being fulfilled. In other words, the software developers believe that there is a service or product that they can provide that will be profitable. The variety of different types of services, content and products that can be offered to users via a software application is limited only by the imagination of the different software developers.

The term “pod service” or “pod application” is used in the following description as a label for software applications offered through the mobile community 202. This label is used merely for convenience and is not intend to limit or restrict the types, variety and capabilities of potential software applications in any way. As used herein, the term “pod” refers both to the underlying information related to the pod application and to the graphical rendering of the pod application on a user's profile page within the mobile community 202.

Once the marketplace is identified, the developer commences development of their software application in step 404. The underlying application logic is up to the developer and can utilize any of the widely known programming environments and techniques available to one of ordinary skill in this area. However, the software application will be offered within the mobile community 202 along with a variety of other software applications. Accordingly, standardizing the look and feel of the application and information about the application will aid the users 212, 214, 216 and make their community experience more enjoyable.

Once a pod application has been developed (and most likely tested and verified) by a developer, the developer registers, in step 406, the pod application with the global mobile platform. Registering the pod application, which is described in more detail later with reference to a number of screenshots, allows the software developer to inform the global mobile platform 306 that a new pod application is available for the access by mobile community 202.

Once a pod application is registered, the global mobile platform 306 updates, in step 408, system databases and directories for the new pod application and its associated information. In the above description of FIG. 4, it is evident that the pod developer communicates with the mobile community 202 for a number of different reasons. One of ordinary skill will recognize that these various communications between the pod developer and the mobile community can occur via any of a variety of functionally equivalent means. For example, both wired and wireless communication methods for these communications are explicitly contemplated within the scope of the present invention.

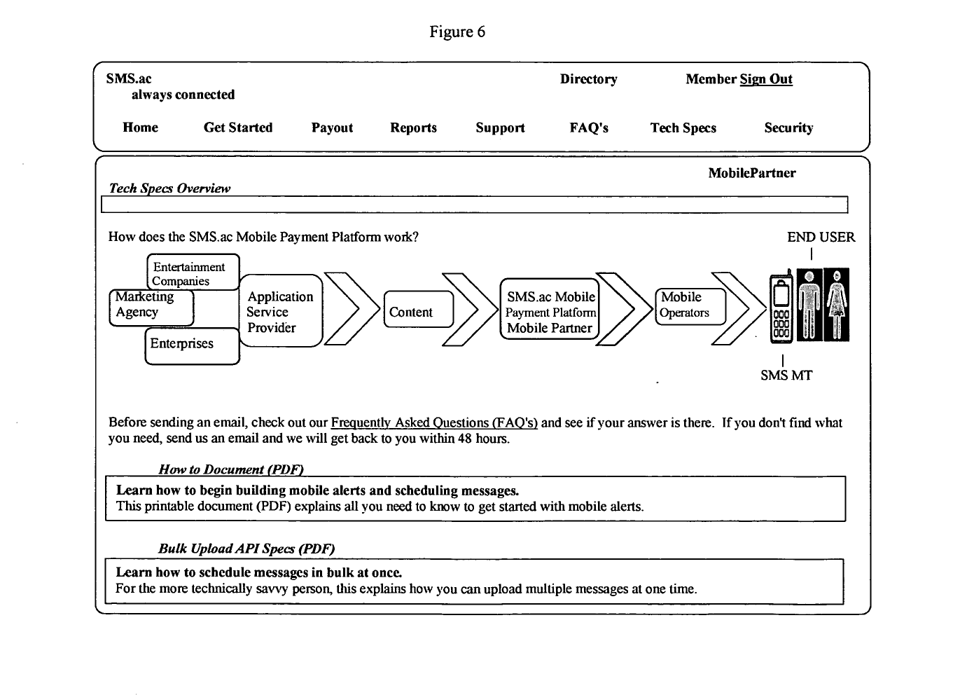

FIG. 5 is a screenshot of an exemplary window that software developers may be presented to assist in registering a new pod. From this screen, the software developer can navigate to a screen that provides more technical information such as the one shown in FIG. 6. This screen illustrates to the developer how the pod application takes advantage of the existing mobile payment platform when used by an end user.

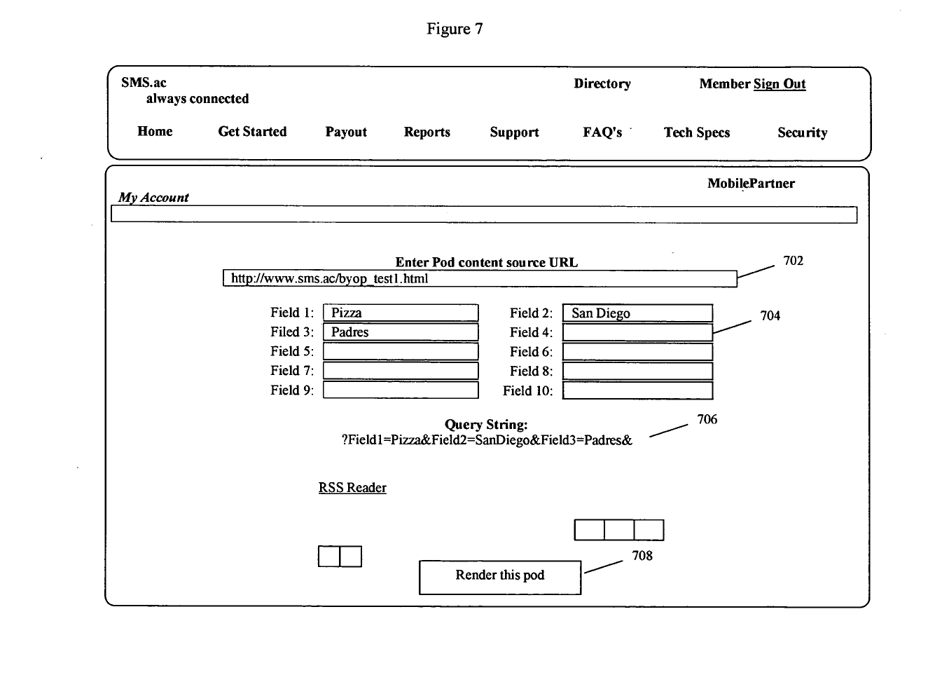

FIG. 7 is a screenshot of an exemplary pod registration screen. Because the pod application is most likely hosted remotely, an input window 702 allows the pod developer to provide the URL of where the pod application is located. When a user ultimately uses the pod within the community 202, this URL is the location from where the content for the pod application is retrieved. For example, if the pod application was developed to display pictures for a dating service, this URL would point to code that when executed could detect user input events and result in the display of appropriate images.

The pod developer can utilize the field input boxes 704 to specify different fields that can capture input when a user first accesses a pod. For example, if a pod application is developed to provide stock quotes, then these fields could be defined to accept stock symbols. When the user views the pod within their profile page, these fields can be filled in with appropriate stock symbols, for example. When the user then selects a “submit” button, this information is sent to the pod application which returns the appropriate information.

As is well known to HTML and HTTP developers, based on the information that is filled in the field windows 704, a particular query string will be appended to a request received from a user's form submission. To aid a developer in registering a pod, this query string is automatically generated and displayed for the pod developer in region 706 of the exemplary screen. To give the pod developer a quick view of how the pod will be rendered, a button 708 is provided to illustrate the pod. With this information, the developer may choose to revise their design.

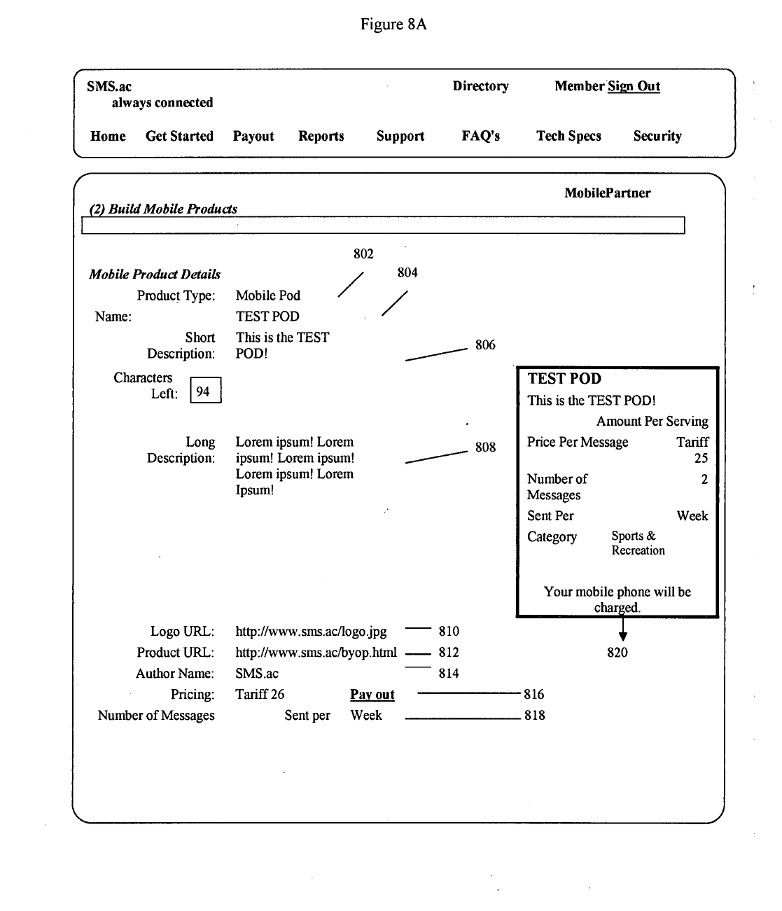

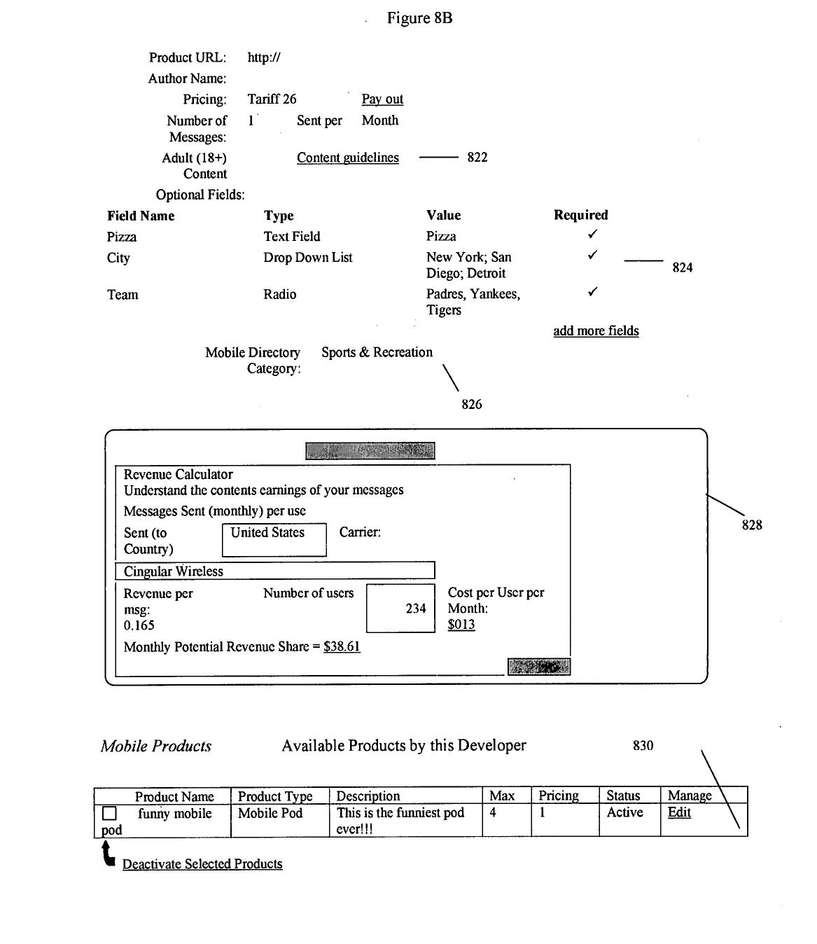

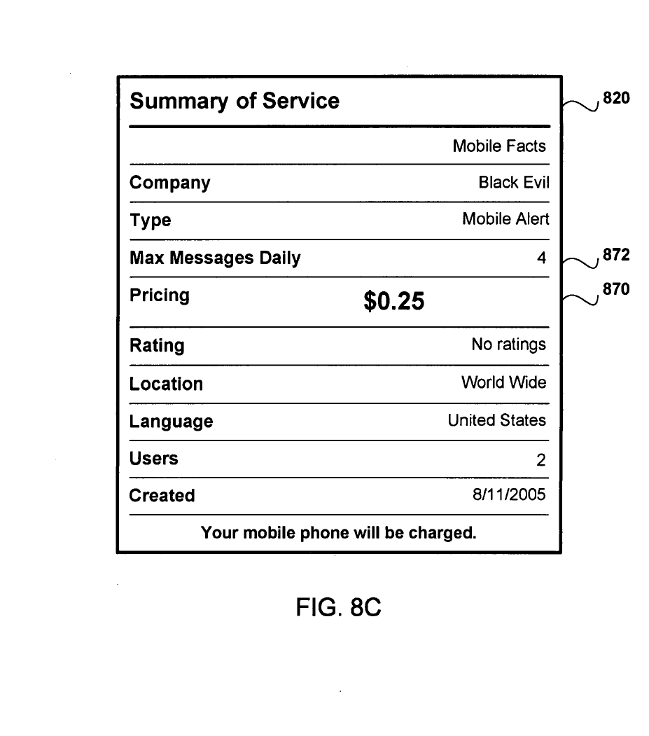

Once this initial information is collected, the global mobile platform 306 collects additional information that is associated with the pod. In FIGS. 8A and 8B, a number of input fields 802-830 are provided for the pod developer to fill in while registering their pod application. Many of these fields are self-explanatory; however, some warrant a more detailed discussion. In particular, a pricing window 816 is available for the developer to select an appropriate pricing scheme, according to a standardized pricing structure. According to one embodiment of the present invention, pricing occurs in fixed tariff bands. For example, one band would be a $0.25 band and would be used for products or services that the developer thinks users would purchase for around $0.25. Another band may be $1.00 and would be for higher priced items and still other bands can be used as well. According to this arrangement, not all prices are available to the developer; instead, the developer picks the closest band to use (e.g., the $1.00 band is selected even if market research shows users would actually pay $1.03 for the service).

Additionally, the pod application will likely be used by people in different countries. Because of the vagaries of global economics, $0.25 may be too high of a price-point in many countries. Thus, it is more appropriate to set a price-point for each separate country from which the pod application may be used. While it is possible for the global mobile platform 306 to permit the pod developer to set such a vast number of price-points, most developers will not have the knowledge or the patience to perform such a task. Accordingly, the global mobile platform 306, automatically provides a price band selection for each country based on their respective costs of living. In other words, a developer can select a price band in the currency that he is comfortable with and let the global mobile platform 306 translate that to an equivalent price band in each country.

Via the input field 818, the developer also specifies the number of messages and frequency that their pod application will send to each user. Based on their knowledge of having developed the pod application to perform a particular service, the pod developer may, for example, know that no more than 4 messages per day (per user) will be sent from their pod application. This information sets the terms and conditions for billing the user. Thus, they would fill in this field 818 accordingly. As explained later, the global mobile platform 306 can use this information to control message traffic within the community 202.

The benefit of specifying the pricing information and number of message information is that the terms and conditions of the pod application can be provided to a user in a uniform manner. Window 820 displays, for the pod developer, how the pod application information, including pricing, terms and conditions, will be shown to a user. FIG. 8C depicts a more detailed view of this uniform pricing display. Much, like nutritional labels on food products provide a uniform format for presenting the nutritional information, the format depicted in window 820 can be used to uniformly present information about pod applications. Thus, a user of the community does not have to learn and interpret different pricing information for each different pod developer. Instead, the uniform format 820 simplifies understanding this information. The exemplary format of window 820 includes a variety of information about the pod application. Of particular interest to most users is the uniform manner in which the pricing information 870 and the message information 872 is clearly presented. One of ordinary skill will appreciate that the format of window 820 is merely exemplary in nature and can vary in numerous ways without departing from the scope of the present invention. Accordingly, the exemplary format of window 820 is provided to illustrate that the global mobile platform 306 is arranged so as to provide users of the community 202 with uniformly formatted information from a variety of different pod applications so as to simplify the evaluation and comparison of different offerings. With such a uniform pricing arrangement being utilized, it becomes possible to monitor the behavior of pod developers with respect to their specified pricing structure and implement control measures such as limiting or restricting their activities within the mobile community if warranted.

Once the information of screens 8A and 8B are submitted to the global mobile platform 306, the pod application is registered with the mobile community 202. According to at least one embodiment of the present invention, the pod application is evaluated by a moderator of the mobile community 202 to ensure it is acceptable from a technical and content point of view for the community 202. In this scenario, the pod application is not registered until the evaluation is completed satisfactorily.

Information about a registered pod application is stored within the global mobile platform 306 in such a way that when a user wants to include a pod on their profile page, the pod can be rendered using the stored information and interaction between the pod and user will occur based on the stored information as well. In such a case, the data associated with the user will be updated to reflect that the user is now accessing and using the pod.

Thus, according to the previously described technique, a pod developer can automatically register a new pod application (even from a remote location) without difficulty in such a way that the pod automatically becomes available to users of the mobile community 202 at the conclusion of the registration process. Furthermore, from the pod developer's point of view, the pod application may immediately take advantage of the billing platform used by the mobile community 202 without the need to have existing contracts in place with one or more wireless carriers.

One benefit of registering pod applications in this manner is that once registered, the global mobile manager 306 can prevent the terms and condition information from being changed by the pod developer. Thus, a user's agreed upon price and operating parameters will not be modified (with or without their knowledge).

The users of the global community can locate available pod applications in a number of different ways. First, the community 202 facilitates sharing of information by people having common tastes. Accordingly, within the community users frequently visit other users profile pages looking for interesting content and information, particularly with neighborhoods to which the user belongs. During this visiting of other members' home pages, a user can discover an interesting pod and want to get it for themselves. In terms of the community, a user “owns” their own profile page and is called an “owner” when at their profile page. In contrast, when a user visits some else's profile page, they are considered a “viewer”. Within the mobile community 202, the profile pages are maintained such that the view by an owner may not always correspond to that seen by a viewer as the owner may want some information to be private and other information to be public.

In another instance, a user may know a friend or colleague would want a particular pod application; thus, the community 202 allows a user to inform another user about the existence of a new pod application. Another way in which pod applications are located is via a directory within the mobile community 202. For example, the global mobile platform 306 registers each pod application as the developers submit them; it is a simple extension to include a database update and a searchable-directory update as part of the registration process (see step 408 of FIG. 4).

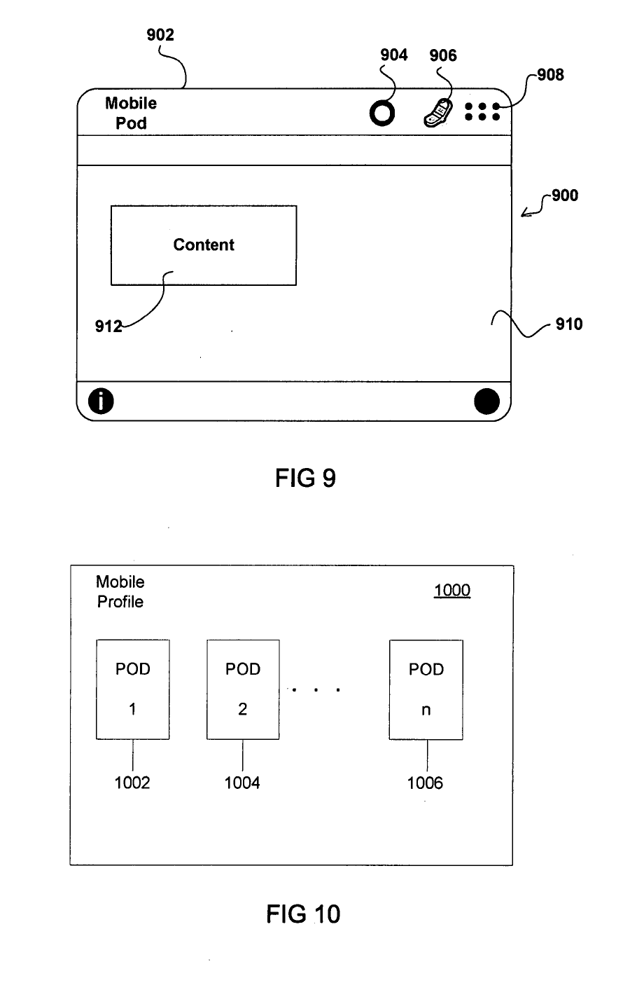

A rendering of an exemplary pod 900 is depicted in FIG. 9. The pod includes a title bar 902 with a number of icons 904-908. The main window 910 of the pod is where the content 912 is displayed. This content is based on the associated pod application and the stored system information associated with this pod. From the pod 900, a user launches an initial message to the associated pod application. In instances where the pod application provides content back to the pod 900, the window 910 is updated. By using remote scripting capability, as is known in the art, the updating of window 910 can occur without the user manually refreshing the window 910. Similar to the profile pages described earlier, the pod 900 can be designed to provide different views of content 912 to a user depending on whether the user is an “owner” or a “viewer”.

The icon 904 can be selected by a user (for example, when viewing someone else's pod) to add that pod to their own profile page. The icon 906 can be selected to inform another user about this pod and a drag icon 908 can be used to move the pod around a user interface screen. The “information” icon 914 is useful for displaying information about the pod, including the uniform pricing information described earlier.

FIG. 10 depicts a exemplary user profile page 1000 that has arranged thereon a plurality of pods 1002, 1004, 1006. In this manner, the pods available to a user can be displayed on their profile page. As noted earlier, the user can access this profile page via a number of different devices. For example, in addition to use of a traditional web browser, a portable device such as a smart phone or PDA can be used to access the profile page and pods. Such portable devices can utilize traditional WAP-based or HTML-based techniques to access the pods but they may also utilize device-based applications with proprietary protocols specifically developed to advantageously utilize the capabilities provided by pods and pod applications. Other example techniques implemented by portable devices that can be configured to access a profile page described herein include BREW, J2ME, etc.

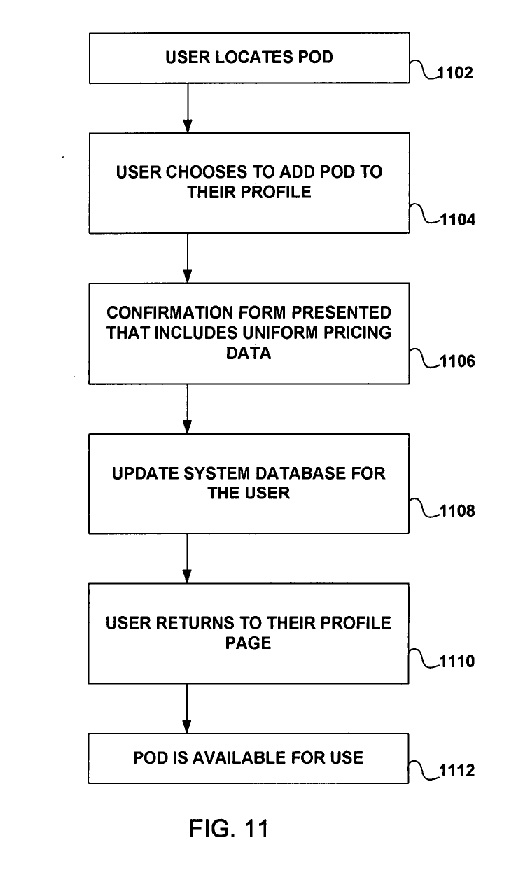

FIG. 11 illustrates a flowchart of an exemplary method for a user to add a pod to their profile page. In step 1102, the pod user locates an interesting pod via a visit to another user's profile page or through a directory search. In evaluating the pod, the user can see the terms and conditions of the pod in the uniform presentation format described earlier. Next, in step 1104, the user chooses to add the pod to their profile page; typically using a standardized feature on the pod. In step 1106, a confirmation page is sent to the user to ensure they know the pricing information about the pod and to ensure they are aware of the likelihood of their wireless service account being billed as a result of executing the pod application. Assuming the user confirms their selection, the user area 304 updates, in step 1108, its data store about this user such that the records indicate the user owns this new pod on their profile page. When the user next visits their profile page, in step 1110, and as a result of the user area 304 rendering their profile page on their browser, the new pod will be displayed. With the pod displayed within the profile page, it is now available for use by the user, in step 1112.

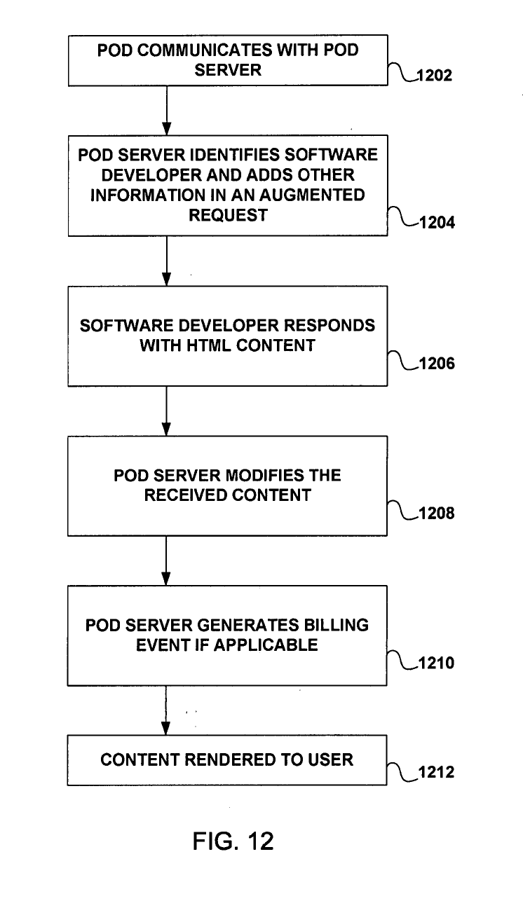

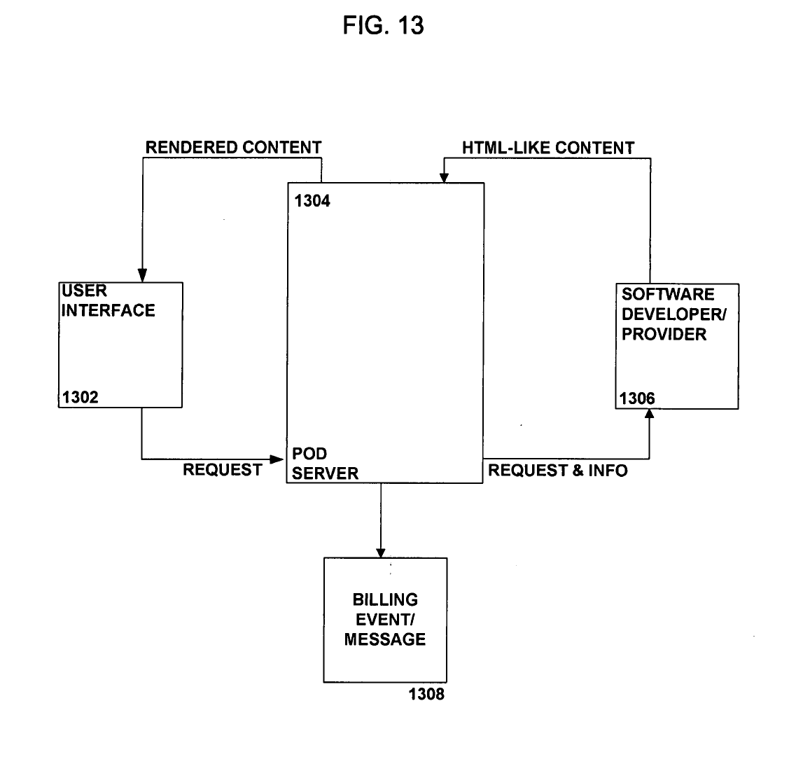

FIGS. 12 and 13 illustrate the operation of a pod and its associated pod application within the mobile community 202. As known to one of ordinary skill, the pod server 1304 may be a process executing on a separate, dedicated processor or may be included as part of the user area 304 or the global mobile platform 306. In step 1202, a user interacts with some feature on the pod user interface 1302 to generate a request. This request, includes the URL associated with the content of the pod and a query string (if any) based on the fields of the pod, and information input by the user. The query string is sometimes referred to as transient parameters.

In response to the request from the pod user interface, 1302, the pod server 1304 identifies the pod developer and the URL of the content and adds some additional information, in step 1204. The augmented request is sent to the software provider's application 1306 which responds, in step 1204, to the augmented request.

The information added to the augmented request can include demographic information about the owner and viewer of the pod. In this way, the software application 1306 can respond with a first type of content if the owner and viewer are the same or respond with different content if the owner and viewer are different. One way to accomplish this distinction is for the user area 304 to refer to users by a unique user ID number. Thus, users can be distinguished without revealing sensitive information to a software developer such as the mobile telephone number of a user. Also, the software application 1306 can use this demographic information to collect statistics about its users.

Other additional information that might be added would include details about the type of user interface the user has available. Because users may be using their mobile device, their display may not be as robust as a desktop interface. Thus, a software application 1306 can control content based on the current graphical and bandwidth capabilities of the user. For example, the additional information can indicate whether the user is operating in a web-based or mobile-based environment, e.g., a WAP, BREW, J2ME, etc., based environment.

In response to the augmented request, the software application 1306 responds with code, in step 1206, that is substantially HTML data. This code is generated according to the application logic of the pod application 1306. In other words, it is the content that is returned to the user who is viewing the pod. In certain embodiments of the present invention, the code of the response varies from conventional HTML in certain ways. For example, because this is a managed communication system, non-standard HTML tags can be used and supported. Thus, non-standard tags can be used that are specific to the pod environment and that are not applicable to generic HTML pages. For example, a pod has a title area and a message area. Tags specifically for controlling these areas may be used to add functionality to the pod environment described herein. One of ordinary skill will recognize that a number of different specialized tags and capabilities can be offered without departing from the scope of the present invention.

An additional variation from HTML is that of using templates where information can be provided by the pod server 1304. For example, for privacy concerns, little identifying information is sent to the software application 1306. However, the pod server 1304 has access to this information because it communicates with the user information stored in the user area 304. Thus, the use of templates will allow software applications 1306 to take advantage of this information to personalize the pod experience. For example, the template may include a tag <! FirstName !>. When the pod server 1304 encounters this tag in the template, it knows that the software application 1306 intends for the pod server to insert the first name of the user. A more detailed list of exemplary template tags is provided in the previously mentioned incorporated document.

When the pod server 1304 receives the HTML-like reply from the software application 1306, the pod server manipulates the reply into a format useful for the pod environment. For example, certain HTML features such as, for example, javascript, iframe, frame, and script features, are removed from the reply in order to improve the security of the content. Secondly, the pod server 1304 can replace the personalizable parameters in the templates with the actual user information. And thirdly, the pod server 1304 can translate the content into other display formats, depending on the operating environment of the user (mobile or computer).

For example, if a software provider is well-skilled in providing WAP code as opposed to conventional HTML code, then that provider can control which code, or content, is generated based on the information it knows about the user's interface. However, if a software provider is not skilled with, or does not support, generating content in different formats, then the software application can request (as part of the code it sends back to the pod server 1304) that the pod server 1304 translate the code into a more appropriate format.

Another modification the pod server 1304 can make is that of manipulating the hyperlinks within the code sent by the software provider. Under normal behavior, such a hyperlink would result in opening another browser window and following the link. As is known to one skilled in this area, the original hyperlinks are adjusted by the pod server 1304 so that following of the links remains under the control of the pod server 1304 and the user interface remains within the focus of the pod instead of some other browser window.

Once the pod server 1304 completes its changes to the original code in step 1208, the server 1304 renders the code and content to the user's pod 1302, in step 1212.

In addition to the code that is received from the software application 1306, the pod server 1304 can also receive information from the software application 1306 about a billing event that should be triggered for the particular content that the user requested. For example, the user may have requested a stock quote that will cost $1.00. When the application 1306 generates the content of the reply, it also generates a message that the pod user should be charged $1.00 for this transaction. One of ordinary skill will appreciate that there is wide variety of protocols for the pod server 1304 and the software application 1306 to exchange information related to a billable transaction. During operation, therefore, the software developer's application 1306 merely adheres to the agreed upon protocols to inform the pod server 1304 that a billable transaction has occurred.

When the pod server 1304 determines that the code from the application 1306 includes an indication that billing should occur, the pod server 1304 generates a billing event 1308, in step 1210. This billing event 1308 is forwarded to the global mobile platform 306 so that billing may occur by using the wireless carrier's underlying billing systems. The pod server 1304 has access to the recipient information (i.e., the pod user) and the billing rate of the pod application 1306. Therefore, an appropriately formatted billing message is easily generated.

The global mobile platform 306 includes a message interface 1402 to handle billing events from a variety of sources. Although a different interface could be designed for each different source of billing events, it is more efficient to use a single Application Programming Interface (API).

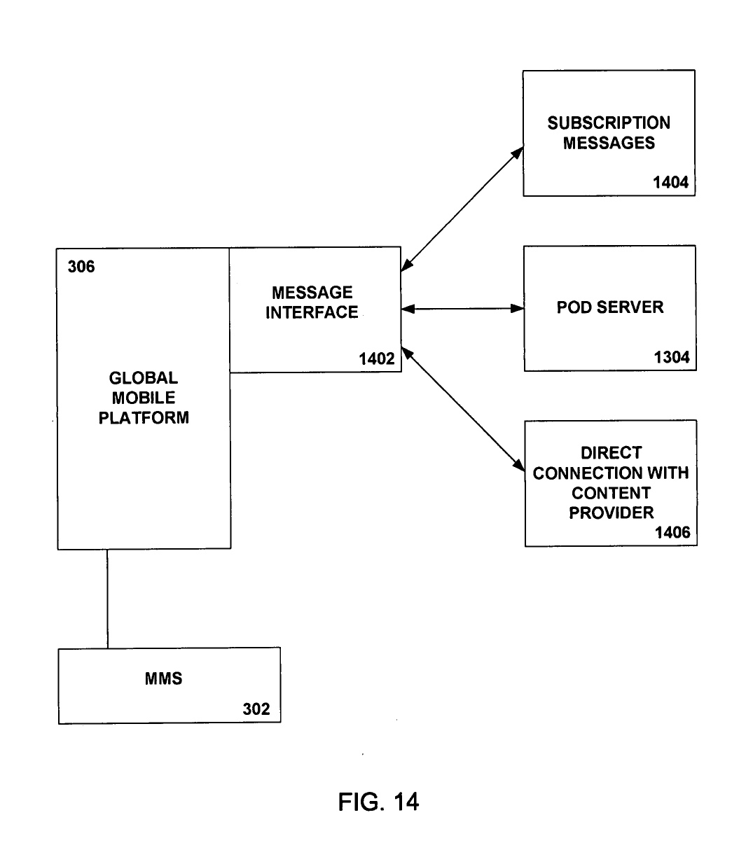

One type of billing message originates from subscription-based services. Under these circumstances, a database or other storage system maintains a record of when to send a message to a user on a predetermined periodic basis (e.g., daily, monthly, weekly, etc.). When the management system for these subscription services indicate that a message is to be sent, then this message is forwarded to the interface 1402 (FIG. 14) of the global mobile platform 306 with the appropriate tariff information included.

As discussed earlier, the pod server 1304 can also generate a message based on a discrete billable event occurring due to the user's operation of a pod application. In this instance the billing message 1308 is forwarded to the interface 1402.

In another circumstance, the pod application may operate so as to avoid sending content back through the pod server 1304 but still be designed to perform a billable event. For example, the pod application may be a virtual greeting card application that sends text messages to people based on whether it is their birthday, anniversary, etc. and charges the pod user $0.25 for each card. Thus, the pod application 1306 performs billable activities but not via the content it sends back through the pod server 1304. Under these event-based circumstances, the software provider can establish a direct connection with the interface 1402 and send a billable message via the established API.

Regardless of how the billable event arrives at the interface 1402, the global mobile platform 306 processes it such that a message is sent via the MMS 302 through the wireless carriers to the user of the pod. This message, the content of which may say, for example, “Thank you for being a valued customer of xxx” will have associated with it a tariff code that results in the user being billed via their wireless service account.

Thus, a business model is established where the wireless carrier bills a user for various events and shares an agreed-upon portion of that billing with the mobile community platform who, in turn, shares an agreed-upon portion of that billing with the software provider. The carrier benefits from additional billable data traffic and the software provider benefits by obtaining instant access to all the users of the mobile community as well as instant access to the wireless carriers' billing systems in a seamless and unified fashion through the platform.

The presence of the global mobile platform 306 between the software provider's application 1306 and the MMS 302 provides the benefit that the messaging of different users of the mobile community 202 can be controlled to ensure the mobile community 202 is more enjoyable.

Within the mobile community, the various computer-based components discussed thus far have a vast amount of information stored and readily accessible. For example some of the information includes: identifying information about each pod application, identifying information about each user, identifying information about which pods are associated with each user, information about the terms and conditions regulating the operations of a pod application, and information about messages being sent via the mobile community 202. With this information available, one of ordinary skill will recognize that a number of operating parameters of the mobile community 202 can be monitored and controlled.

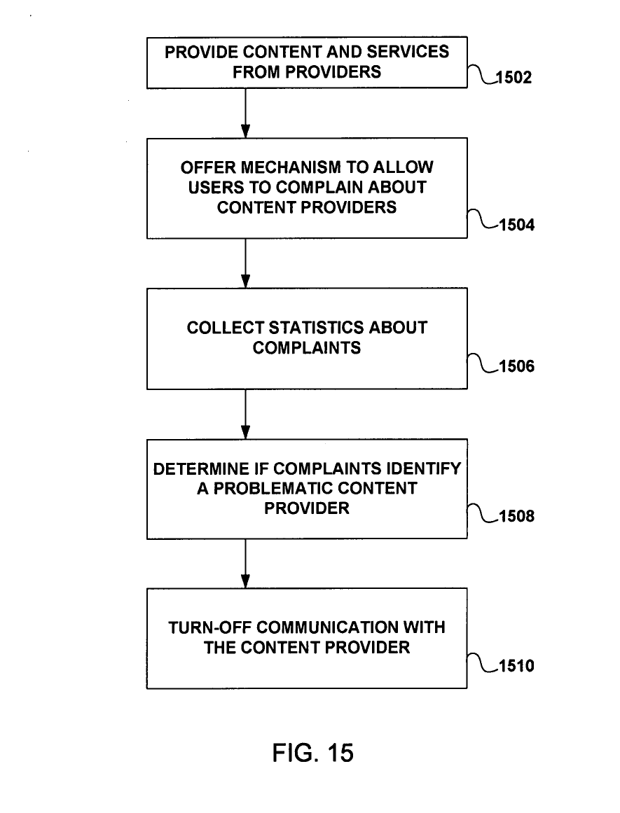

FIG. 15 depicts a flowchart of an exemplary method for instituting a complaint department within the mobile community 202, which can ultimately result in automatic cut-off of access to, and billing activities by, a software application. In accordance with this flowchart, while all the parties are using the mobile community 202, content and services are being provided by different software application providers in step 1502. Within the profile page of a user, or alternatively at a more centrally located page, a link may be provided, in step 1504, to submit a complaint. The global mobile platform 306 then collects these complaints and generates, in step 1506, statistics about them. For example, one statistic may be to identify what percentage of users of a pod application are complaining that it fails to operate as promised, provides unsuitable material, improperly bills, or includes some other problem.

In step 1508, the complaint statistics are evaluated to determine if a problem exists. Typically there would be checks and balances used to ensure that a single user is not abusing the system with a flood of complaints or that receipt of 100 complaints is not really a problem if the user base is 10 million. If a problem is found to exist with a particular pod application, then in step 1510, the global mobile platform turns-off communication with this pod application. Thus, the pod server can be informed to ignore any communications to or from that particular application. Because a software provider may supply more than one pod application, it is contemplated that the system could turn-off communication with all applications from that provider, not simply the ones relating to only the problematic application.

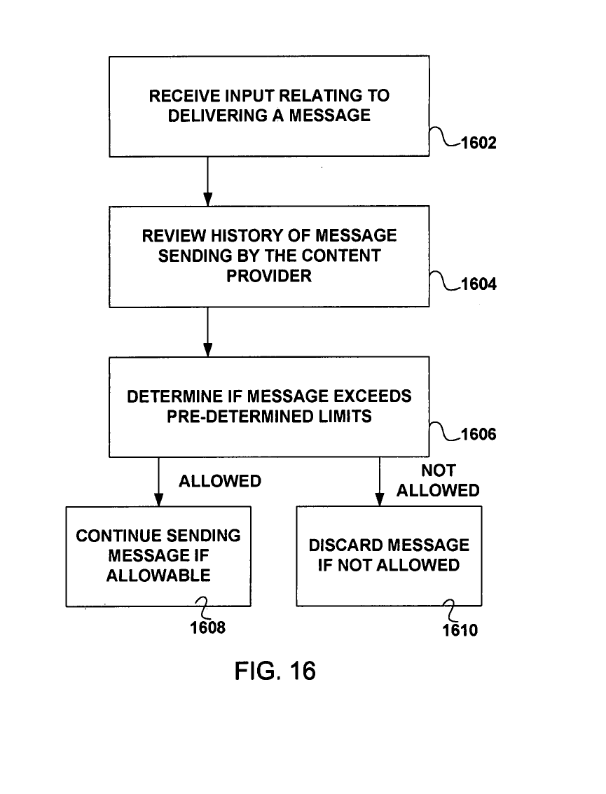

FIG. 16 provides a flowchart of an exemplary method for regulating messages such that the agreed upon terms and conditions of the operating parameters of the pod application are adhered to. At the time a subscriber decides to subscribe to an application, the subscriber is shown details relating to price, message frequency, maximum messages in any given time period, and other terms relating to the specific application. Upon agreeing to those terms and conditions, those terms and conditions are memorialized for that specific subscriber within the online community, such that if the application provider later changes the price or other terms of the service, such new terms will only apply to the new subscribers that enter a “contract” after the date of change. The system ensures enforcement of the original terms and conditions that each individual subscriber was shown and agreed to.

In step 1602, the global mobile platform 304 receives via its interface 1402 a message to send to a user. As part of the agreed upon API, the message arrives from an identifiable source and specifies the recipients for the message. A recipient can be a single user or it could be a group such as “San Diego Padre fans,” which the system will expand into the individual subscribers when delivering the message.

Thus, in step 1604, the global mobile platform analyzes historical information about messages sent by this sender to the specified recipient. In step 1606, this historical data can be compared to the pre-defined limits for the message sender. If the message would cause the pre-determined limits to be exceeded, then the message is discarded in step 1610, thereby avoiding billing of the user. If the message is allowable, then the message is sent as normal in step 1608.

In the above description of the various aspects of the present invention, the specific example of a software application provider was described in detail. This specific example was provided merely to highlight many of the features and aspects of the present invention, but one of ordinary skill will recognize that providers of other types of products and services may also utilize and benefit from the mobile community system of FIG. 2. In particular, embodiments of the present invention allow vendors of all types of products and/or services to charge for their products via the mobile community's existing connectivity to the various carrier systems. In practice, a purchaser would consummate a transaction with a vendor for some product or service and, in the process, provide to the vendor a means of identifying that user within the mobile community. The vendor, in turn, will communicate with the mobile community (e.g., via the Global Mobile Platform) to initiate a billing event that identifies the purchaser and the transaction amount. As explained above, this billing event will result in the purchaser being billed via their wireless telephone subscriber account. In this way, the wireless telephone account (although this information is not necessarily revealed to the vendor) acts as a virtual wallet allowing the purchaser to easily pay for a variety of different types of transactions.

As mentioned above, mobile platform 202 makes available a plurality of services and applications or pods to users 212-216. But also as mentioned above, the users 212-216 must access mobile platform, and the applications and services provided, using a browser, which can make integrating the use of such applications and services with the use of applications stored on the users desktop difficult, or at least inconvenient. In certain embodiments, mobile platform 202 can be configured to provide many of the applications normally stored on a user's desktop. Still, there will often arise a need, or desire to access content or applications stored on the user's desktop.

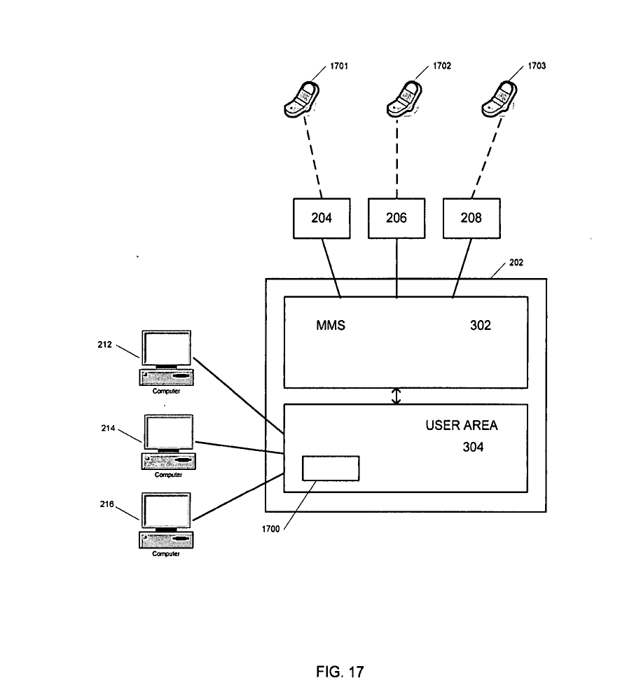

Ideally, the community-based applications and services provided by mobile platform 202 can be integrated in a more seamless fashion with desktop based applications and services. In this regard, FIG. 17 is a block diagram that illustrates initial access to a desktop user interface application according to one embodiment. As seen in FIG. 17, a desktop download module 1700 can be provided in user area 304. Desktop download module 1700 can be accessed by users 212, 214 & 216 when the user accessed community platform 202. For example, the option to download the integrated desktop user interface application can be presented on the user's home page upon signing into community platform 202 via the user's web browser. The user can then elect to download desktop download module 1700 to the user's computer, which then installs the integrated desktop user-interface application of the invention on the user's computer.

In the alternative, the mobile device users 1701, 1702 and 1703 can access the download desktop download module 1700 when they access their home page on community platform 202 through message service 302, which communicates with user area 304. In this manner, the integrated desktop user interface application of the invention can support both computers and mobile devices in coordination with web browser used on each device, respectively.

Once downloaded and installed, the integrated desktop user interface application resides on the user's desktop for convenient access and use of the tools, services, and products offered through the community platform 202. During installation of the desktop user interface application, the user can set preferences, such as whether to load the desktop user interface application upon start-up of the computer or mobile device, automatically install updates, etc. In addition, the user can choose to import the user's address books from other third-party applications/services, such as Hotmail, MSN, AOL, etc., so that all of the user's contacts can be aggregated in the desktop user interface application. Optionally, the user can select to have the desktop user interface application check each of the user's third-party address books on a periodic basis (weekly, etc.) to incorporate any additions, changes, etc.

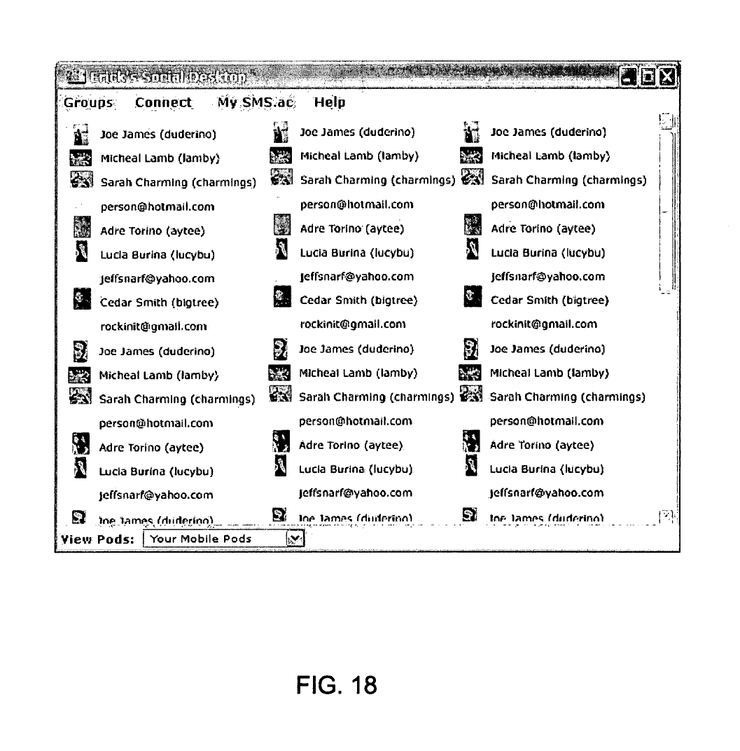

The desktop user interface application presents a main desktop module window that appears on the user's desktop as an application. The user can sign in to the community platform through the desktop user interface application and remain signed in until signing out or shutting down the computer or mobile device, as the case may be. An example of the main desktop module window is shown in FIG. 18. As can be seen in the screen shot of FIG. 18, the main desktop module can include the user's contacts from user area 304, as well as from other third party applications of services. Contacts that are known by platform 202 can have associations, such as a picture or other image or graphic, based on associations stored on platform 202. Those contacts without associations can represent third party contacts that are unknown to platform 202, i.e., are not stored in user area 304.

When the desktop application is being downloaded, or installed, the installation process should check for previous installs and migrate personal content from previous versions. In certain embodiments, the user can be notified and confirm installing over an older version and migration of personal content. In certain embodiments, it can also be preferable for the download and installation process to be a combined experience during which a user can set up preferences during installation such as configuring the desktop application to automatically start whenever there is a system re-start, install files to default location, and automatically download and install newer versions. Further, in certain embodiments, during installation, a simple demo can run to illustrate drag and drop capabilities, described in more detail below, and other key features such as adding friends, launching pods, etc. This demo can, e.g., be accessed from a help menu after installation

During installation, the user can have the option to install a browser toolbar, make the user's profile page the user's home page, be offered the option to import address books from supported programs, e.g., Hotmail, MSN, AOL, etc. The user can also enter an account name and password to import address book contacts from different programs if needed. All address book fields should get imported into the address book associated with the user's profile page. Further, to the extent there are any, pictures associated with every contact should get imported into the user's address book.

In certain embodiments, the user can have the option to keep the address book synched based on preset schedule, e.g., weekly, and the user can have the option to send an email to invite friends to enjoy using this product, e.g., for free.

Once the desktop application is downloaded, the user can launch it from the desktop in several manners, such as from the system tray. The user can dismiss the module at any time by clicking on the x in the display; however, the user should still remain authenticated after dismissing the main module. A screen can show that the social desktop is still active and can be launched from the system tray.

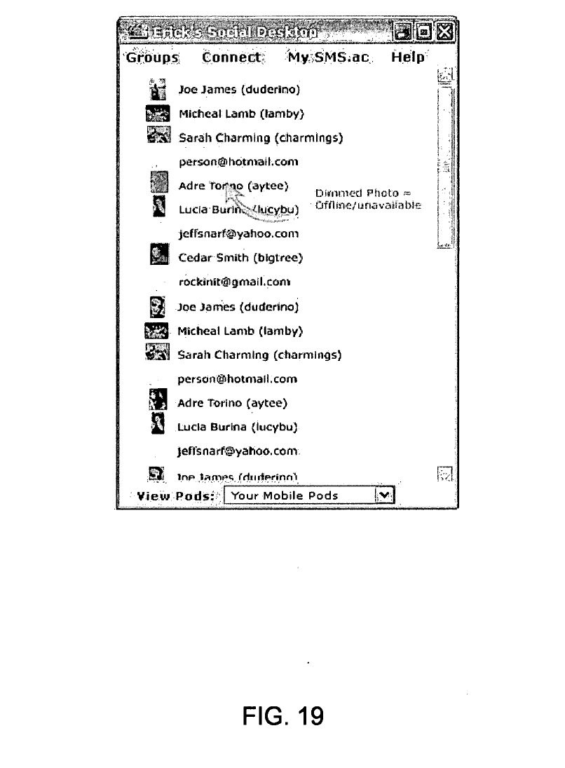

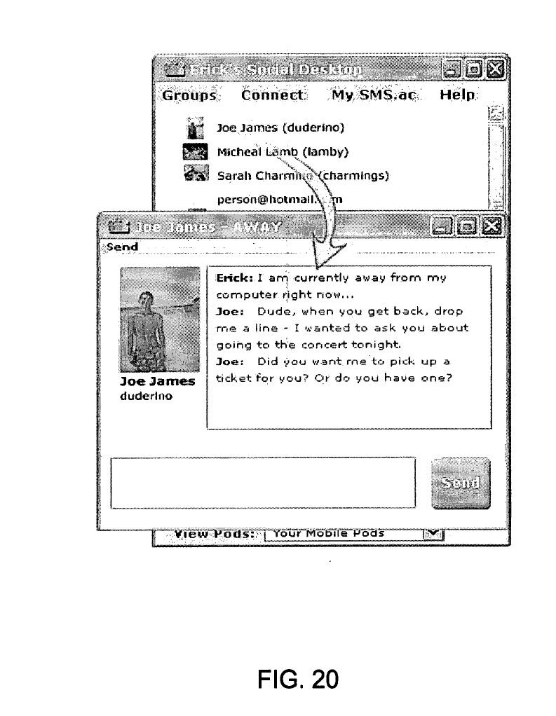

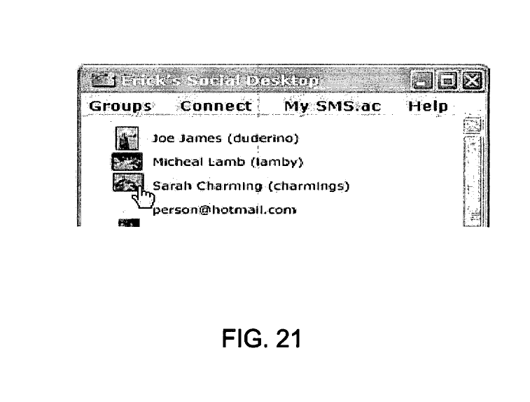

The main desktop module window is managed on the user's desktop similar to an application window. As noted, the main desktop module window can contain a list of all of the user's contacts, along with corresponding thumbnail pictures of the contact. In certain embodiments, the shading of each listed contact indicates whether that contact is currently available online, or away, of purposes of instant messaging, as shown in the screen shot of FIG. 19. Further, in certain embodiments, the user can click on a contact to initiate instant messaging with that contact, as shown in the screen shot of FIG. 20. In addition, multiple contacts can be selected within the main desktop module window by selecting and clicking on them, and rubberband selecting them by moving the cursor around the desired group of contacts as illustrated in the screen shot of FIG. 21.

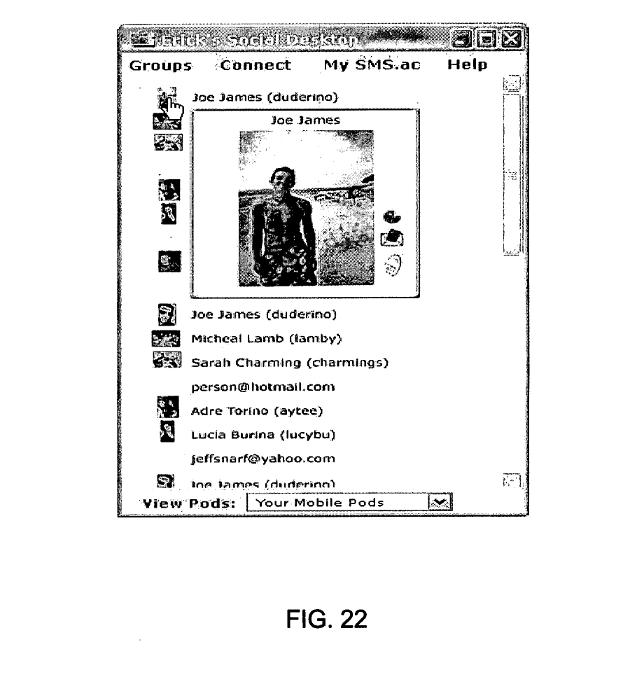

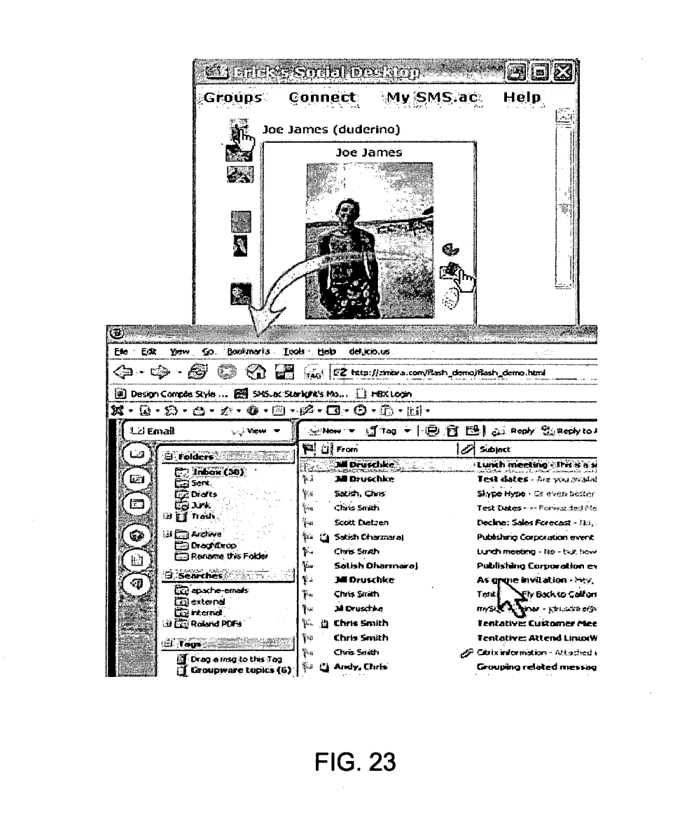

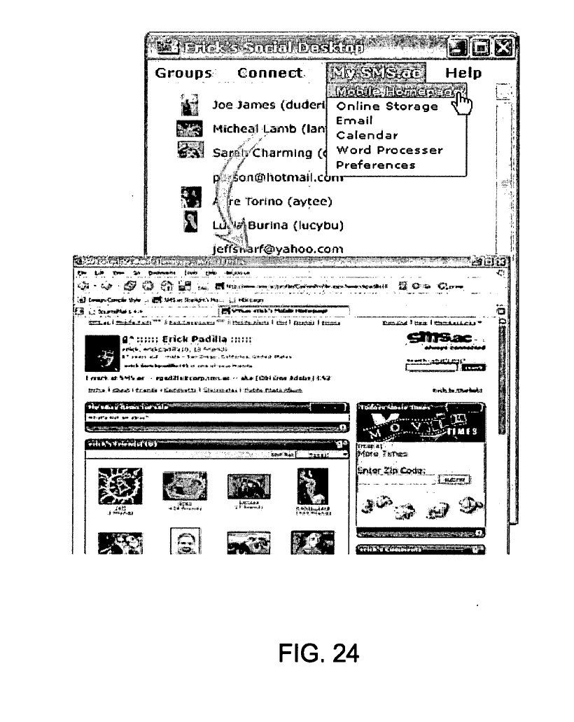

When a contact, or multiple contacts, are selected, the user can point over the desired contact(s) and a menu can pop-up which includes icons representing various forms of communication tools for the user to select from (FIG. 22). For example, the user can select to instant message with the contact(s), send an email to the contact(s), send SMS to the contact(s), Chat with the contact(s), use voice-over-IP (VOIP) to communicate with the contact(s), or videoconference with the contact(s). In certain embodiments, the user can also click on a contact to go to that contact's home page provided through the community platform (FIG. 23). The user can also access their own home page directly from an option in a drop down menu of the main desktop module window (FIG. 24).

It should be noted that in certain embodiments, access to the user's desktop, and therefore the desktop application, can be made available to other parties. For example, parties in the user's contact list can be granted access to the user's desktop, e.g. via a link on mobile platform 202. As such, the desktop application can be transformed into a social desktop application that allows the user to not only communicate with other users and share files and other information from the user's desktop, as described below, but to also allow those users to actually access the user's desktop. For example, certain users who download the desktop application can be granted access to other users who have downloaded the desktop application. Such users can be identified as members of the mobile community, i.e., those who have joined the social desktop.

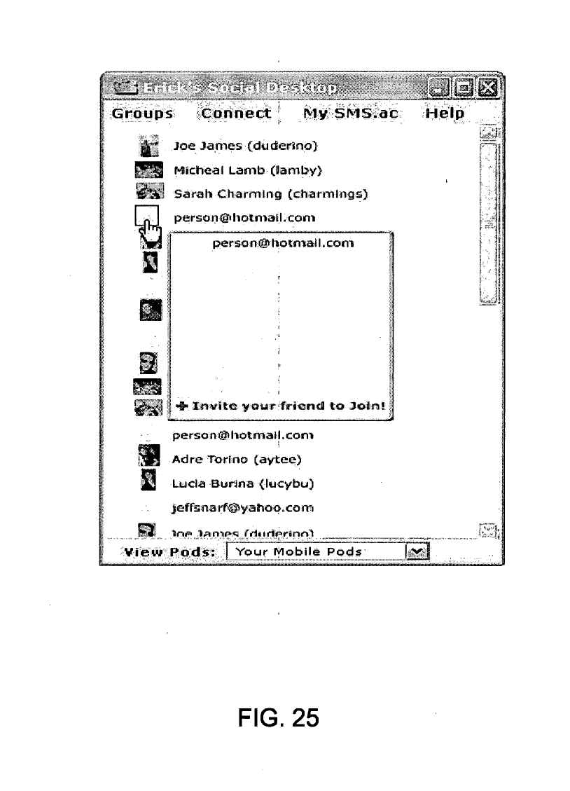

As illustrated in the screen shot of FIG. 25, if user is not a member of mobile platform 202 and/or the social desktop, a default avatar can be assigned to that contact. When the user hovers the mouse pointer over such a contact, an invitation link can be generated for the user to invite that person to join. An email message can then be sent to that user, inviting them to use social desktop and indicating that their friend is already using it.

The drop down menus of the main desktop module window can provide functionality for the user to add and manage the user's contacts into groups. For example, when the user selects the group drop down menu, a drop down menu can be generated that identifies all different groups user has already created, such as family, colleagues, classmates, soccer team, surfing buddies, etc. The user can select any type of group from the drop down and the main pane will update accordingly by showing only thumbnails of such selected groups. The user can also add a new group by selecting any thumbnails from the main window and putting them into a new group by enter a new group name and clicking on submit. The user can also select any thumbnails from the main window and move them into a new group. In certain embodiments, the user can decide if this is to be a copy or move operation.

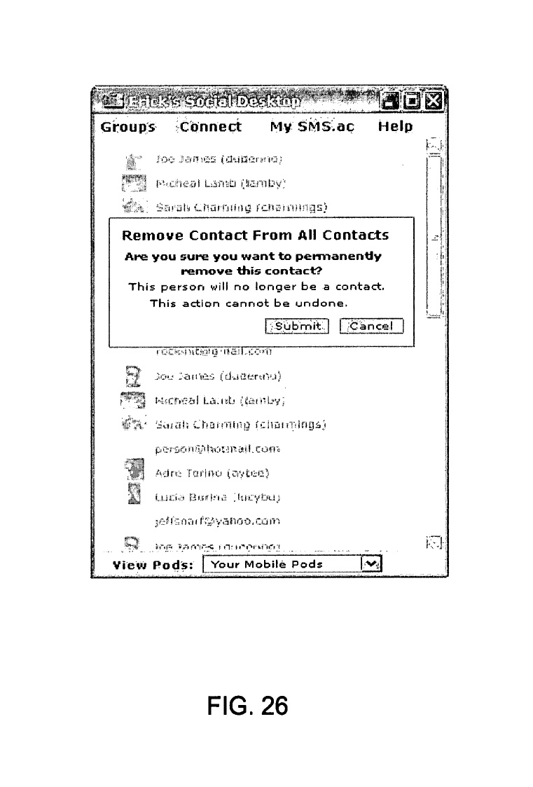

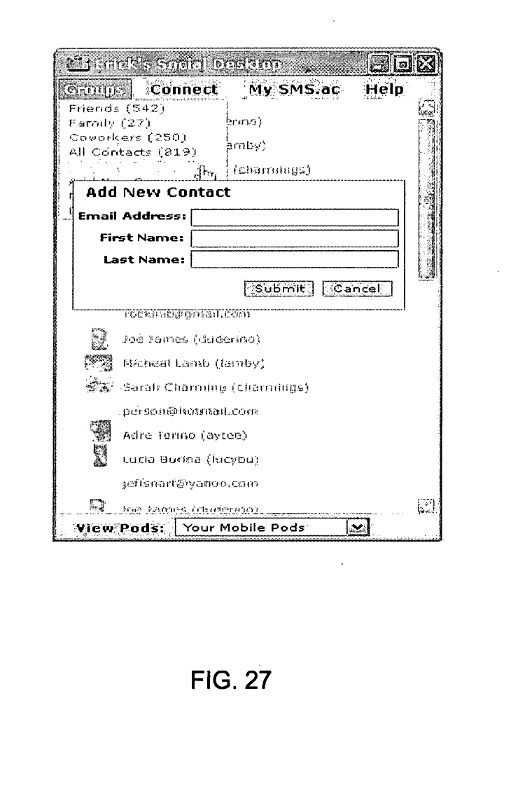

A user can select any thumbnails, i.e., contacts, from the main window and remove them from a group as illustrated in FIG. 26. If the remove action is taking place in the all contact group, the user can be warned such action will permanently remove such person from this group as well as from all other groups. The user can also add a new contact into an existing group displayed on main window as illustrated in FIG. 27. Any added contacts will also appear in the all contacts group. As seen in FIG. 27, email addresses, last names, and first names can be required entry fields when adding a contact.

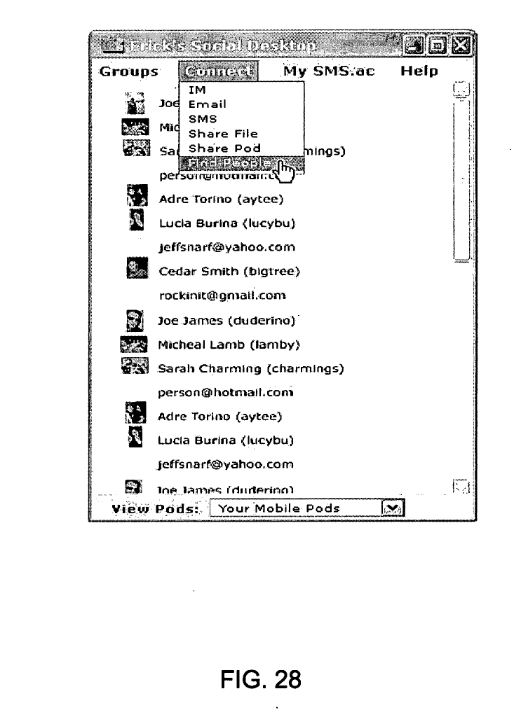

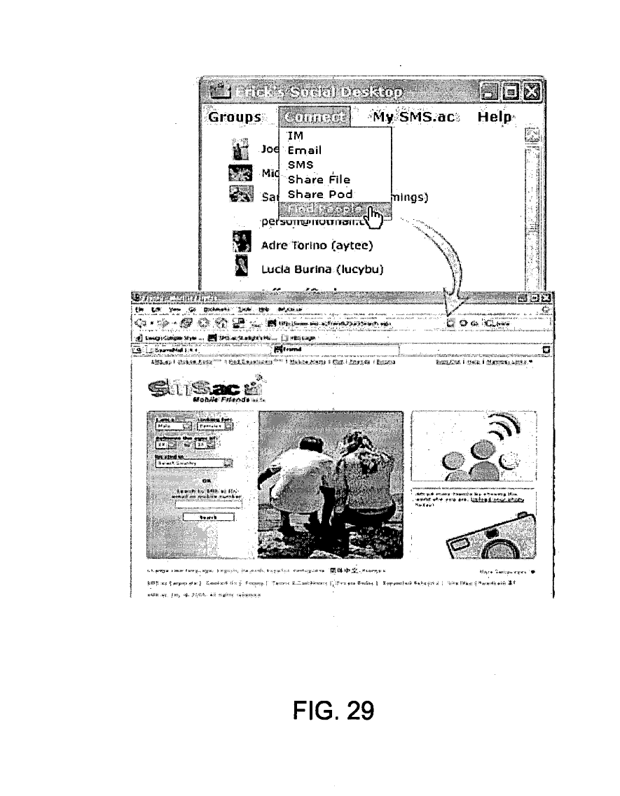

In addition, the drop down menus of the main desktop module window can provide functionality for the user to connect with the user's contacts and with members of the community platform via instant messaging, email, SMS, VOIP, teleconference, videoconference, blog entries, and Chat, as further illustrated in FIG. 28. An option is also provided for the user to go directly to a search page provided by the community platform to search for other members of the community, and the main desktop module window also provides the functionality for the user to share files and pods with the user's contacts, as illustrated in FIG. 29.

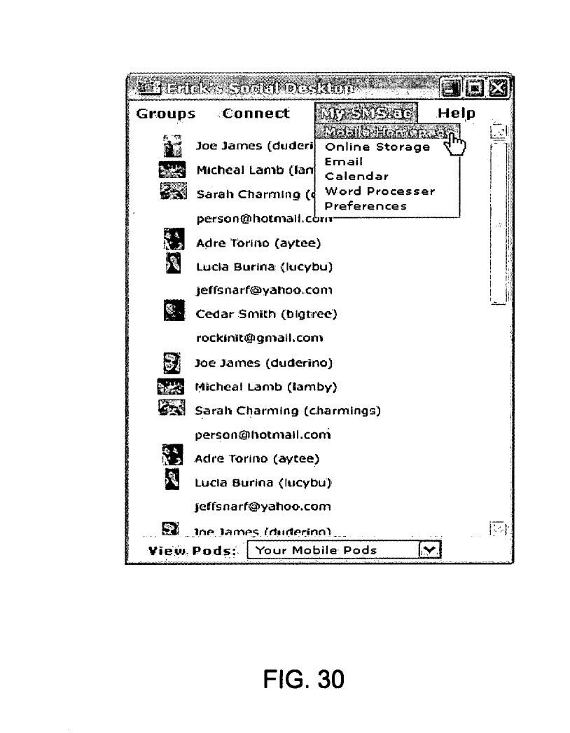

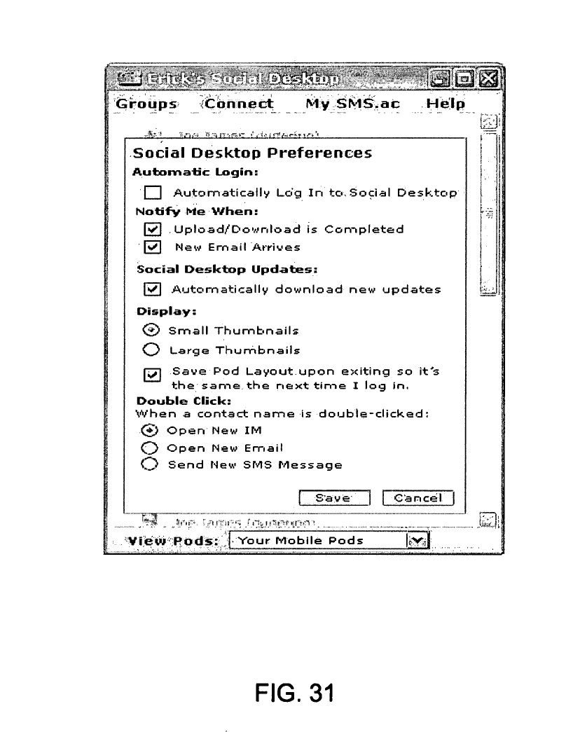

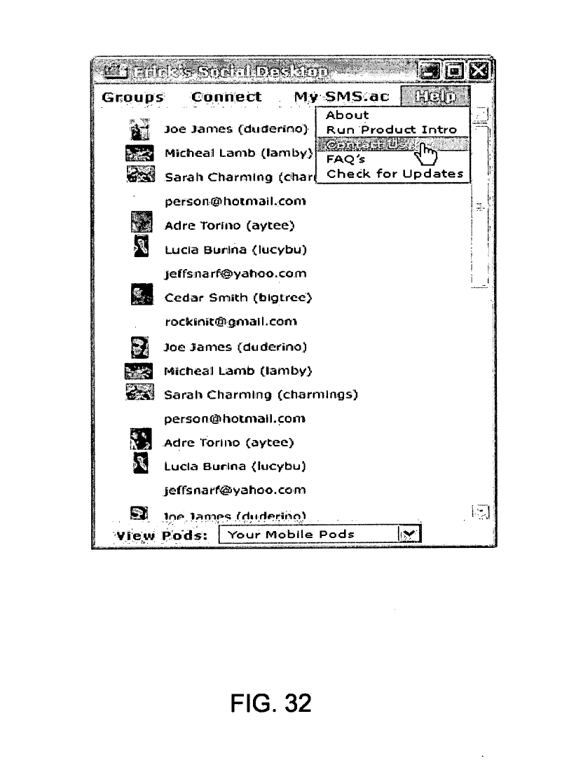

The drop down menus of the main desktop module window can also provide functionality for the user to go directly to the user's homepage, access an online data storage space provided for the user by the community platform, access, e.g., an email application, calendar application, word processor application, and access the user's preferences, as described and illustrated in FIGS. 30 and 31. Help features are also provided to the user via drop down menus of the main desktop module window, as further illustrated in FIG. 32.

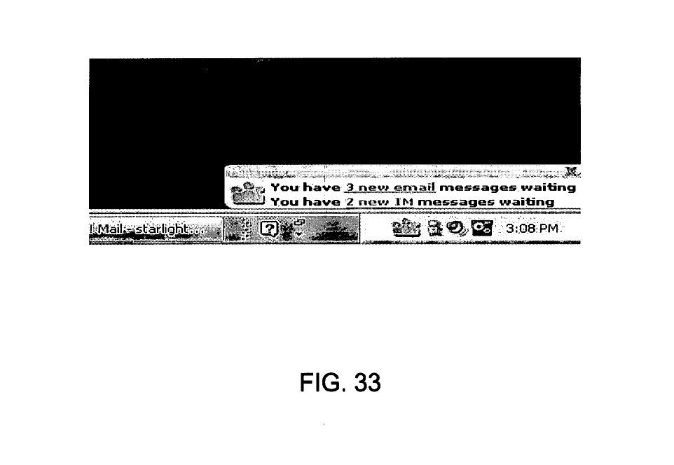

The desktop user interface application also provides notifications to the user via the system tray of the user's desktop. As illustrated in FIG. 33, the notifications can be via a “toaster” pop-up. The notices can include notices of new emails, SMS, etc. In general, the windows icon tray can be used for a variety of alerts. In certain embodiments, an icon will blink when an alert is activated. The initial notification can be via a pop-up, such as the toaster pop-up of FIG. 33, which states the nature of incoming alerts. The message can also indicate the number of messages or other types of alerts are waiting their attention.

In certain embodiments, the user will have the ability to configure these settings under the preferences drop down menu. For example, the user can be allowed to turn the alerts on or off, e.g., by product, i.e., email messages, instant messages, newsletters, etc.

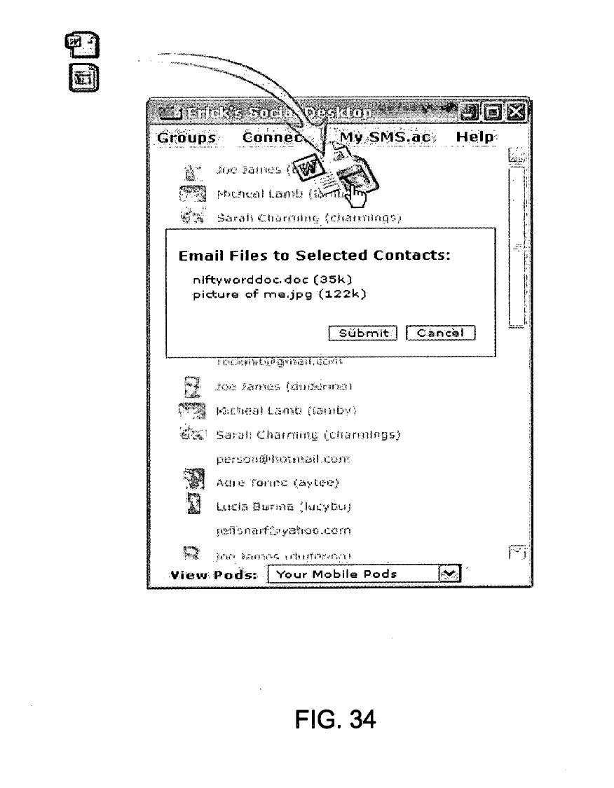

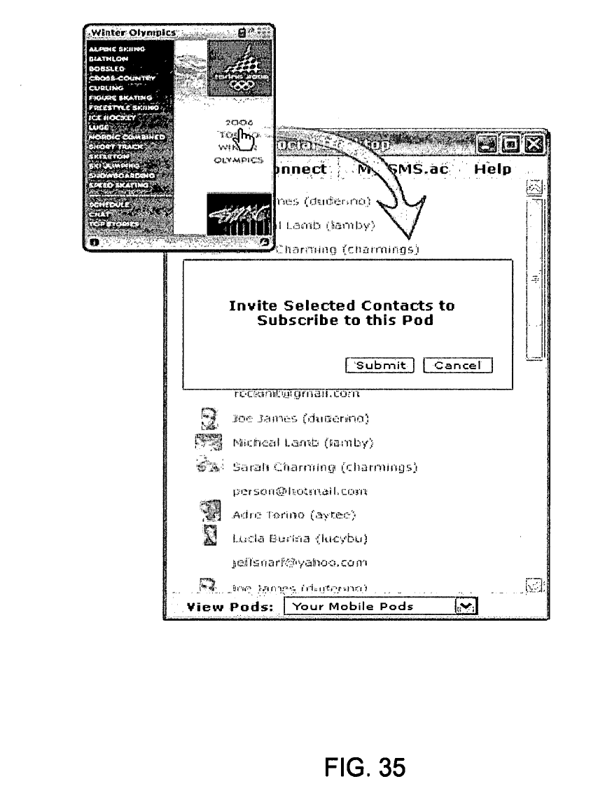

As mentioned above, the desktop user interface application supports convenient file and pod sharing capabilities. In this regard, the user can browse for files from the desktop or any application window, and then drag-and-drop them onto selected contacts in the user's contact list, and the files and/or pods will be automatically sent to the contacts by email, as further illustrated in FIGS. 34 and 35.

A pull down, or other menu in the main desktop module window can provide direct access to the pods that the user has purchased for access and use, and the user can also “undock” these pods from the browser page that the pod appears in and then dock the pod to the user's desktop. In this manner, the user can directly access third-party applications and services on their desktop without having to launch a browser and go to specific websites and without having to download software to support each application pod. A pod that is docked to the user's desktop allows the user to take advantage of the real estate available on the entire desktop and enlarge the pod as desired. In addition, the user can upload multiple objects (files, pods, etc.) to centralized storage space provided through the community platform for subsequent access by other designated users who are notified of the sharing invitation by email.

The user of the main desktop module window can also use the community-based tools offered through the community platform to rate pods, share content, find other users of the same pod, get information about developers of a pod, etc. For example, pods can be added to the drop down menu when the user purchases a pod from the mobile pod directory on mobile platform 202, when a user selects “add pod” from a friend's profile page and goes through the purchase process, when the user selects a pod for a trial or other free pod promotion, and when the user selects a utility pod or free pod.

Once a user selects a pod from the drop down menu, it will appear on their desktop. The user can then launch each pod if desired. Each pod can have a drop down menu in the upper left corner with such basic options as share, e.g., users can share pods with one another, and rate, e.g., users are able to rate the pod from this option by simply clicking on the star (1-poor, 5-great). This information can be displayed on the mobile pod directory page for the rated pod. A review option can also be available, e.g., a free form text box with 200 character limit for users to enter a review. This information can also be displayed on the mobile pod directory with the corresponding pod and other users' reviews.

A search option can also be included, e.g., users will have the ability to see who else purchased the pod by selecting a search option. This can produce a listing of other users' names who have purchased the pod. In certain embodiments, a user can select a name, and a browser window will open to that user's page.

An information option can also be included that allows the user to access pod info such as the developer name and pricing information.

The embodiments of the desktop application described above are generally described in relation to a desktop computer. As mentioned above, however, the desktop application can also be downloaded to a mobile device, such as devices 1701-1703. A mobile device can include a wireless type handset, as well as a Personal Digital Assistant (PDA), palm computer, digital music player, or even a laptop or portable computing device. In general, the desktop application can be downloaded to any device that includes an operating system capable of supporting the desktop application.

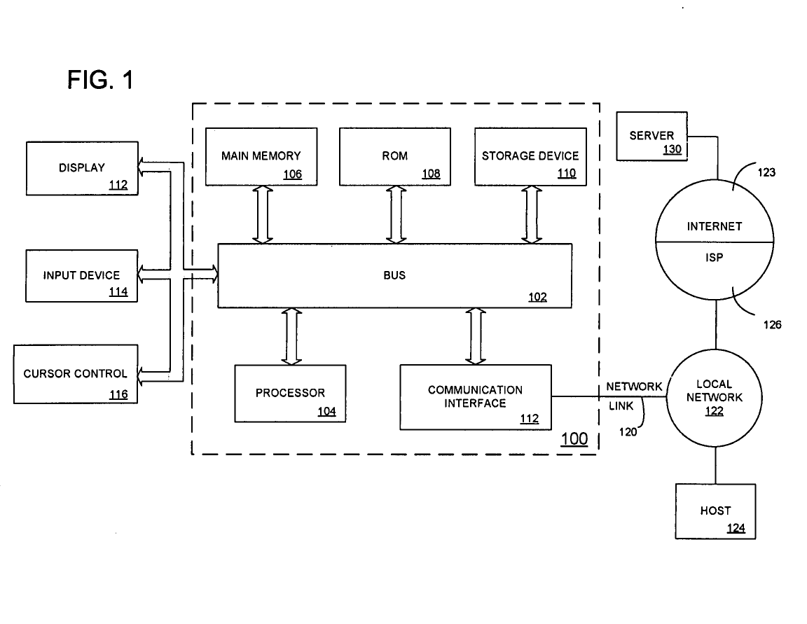

At least portions of the invention are intended to be implemented on or over a network such as the Internet. An example of such a network is described in FIG. 1. The description of the network and computer-based platforms that follows is exemplary. However, it should be clearly understood that the present invention may be practiced without the specific details described herein. Well known structures and devices are shown in block diagram form in order to avoid unnecessarily obscuring the present invention.

FIG. 1 is a block diagram that illustrates a computer system 100 upon which an embodiment of the invention may be implemented. Computer system 100 includes a bus 102 or other communication mechanism for communicating information, and a processor 104 coupled with bus 102 for processing information. Computer system 100 also includes a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT), for displaying information to a computer user. An input device 114, including alphanumeric and other keys, is coupled to bus 102 for communicating information and command selections to processor 104. Another type of user input device is cursor control 116, such as a mouse, a trackball, or cursor direction keys for communicating direction information and command selections to processor 104 and for controlling cursor movement on display 112. This input device typically has two degrees of freedom in two axes, a first axis (e.g., x) and a second axis (e.g., y), that allows the device to specify positions in a plane.

Computer system 100 operates in response to processor 104 executing one or more sequences of one or more instructions contained in main memory 106. Such instructions may be read into main memory 106 from another computer-readable medium, such as storage device 110. Execution of the sequences of instructions contained in main memory 106 causes processor 104 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as main memory 106. Transmission media includes coaxial cables, copper wire and fiber optics, including the wires that comprise bus 102. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 104 for execution. For example, the instructions may initially be carried on a magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector can receive the data carried in the infra-red signal and appropriate circuitry can place the data on bus 102. Bus 102 carries the data to main memory 106, from which processor 104 retrieves and executes the instructions. The instructions received by main memory 106 may optionally be stored on storage device 110 either before or after execution by processor 104.

Computer system 100 also includes a communication interface 118 coupled to bus 102. Communication interface 118 provides a two-way data communication coupling to a network link 120 that is connected to a local network 122. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals that carry digital data streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the world wide packet data communication network now commonly referred to as the “Internet” 128. Local network 122 and Internet 128 both use electrical, electromagnetic or optical signals that carry digital data streams. The signals through the various networks and the signals on network link 120 and through communication interface 118, which carry the digital data to and from computer system 100, are exemplary forms of carrier waves transporting the information.

Computer system 100 can send messages and receive data, including program code, through the network(s), network link 120 and communication interface 118. In the Internet example, a server 130 might transmit a requested code for an application program through Internet 128, ISP 126, local network 122 and communication interface 118. The received code may be executed by processor 104 as it is received, and/or stored in storage device 110, or other non-volatile storage for later execution. In this manner, computer system 100 may obtain application code in the form of a carrier wave.

While certain embodiments of the inventions have been described above, it will be understood that the embodiments described are by way of example only. Accordingly, the inventions should not be limited based on the described embodiments. Rather, the scope of the inventions described herein should only be limited in light of the claims that follow when taken in conjunction with the above description and accompanying drawings.

What is claimed is:

1. A desktop platform configured to interface with a network platform, the network platform configured to support a plurality of network-enabled applications and maintain contact information for a user, the desktop platform comprising:
a display;
at least one processor;
at least one interface having access to the internet; and
at least one computer readable medium carrying one or more sequences of instructions for interfacing the desktop platform with the network platform, wherein execution of the one or more sequences of instructions by the one or more processors causes the one or more processors to perform:
a contact download step of downloading, in the desktop platform, the contact information maintained by the network platform via the at least one interface;
a displaying step of displaying, in the desktop platform, a window that includes the contact information on the display;
a selection step of receiving, in the desktop platform, a selection of an application or content residing on the desktop platform; and
a sharing step of sending, in the desktop platform, the selected application or content to a contact included in the contact information via the at least one interface, wherein the sharing step is achieved by dragging the selected application or content into the window and dropping the application or content onto a contact include in the contact information.

2. The desktop platform of claim 1, wherein execution of the one or more sequences of instructions by the one or more processors causes the one or more processors to perform an application download step of downloading, in the desktop platform, one or more of the plurality of network-enabled applications to the desktop platform via the at least one interface.

3. The desktop platform of claim 1, wherein the sharing step further comprises sending the selected content or application to multiple contacts by highlighting, in the desktop platform, multiple contacts and dropping the selected application or content onto the highlighted contacts.

4. The desktop platform of claim 2, wherein highlighting multiple contacts comprises rubberband selecting the multiple contacts.

5. The desktop platform of claim 1, wherein execution of the one or more sequences of instructions by the one or more processors causes the one or more processors to perform a grouping step of receiving, in the desktop platform, and indication that one or more contacts should be placed into a group.

6. The desktop platform of claim 1, wherein execution of the one or more sequences of instructions by the one or more processors causes the one or more processors to perform a third party contact download step of downloading, in the desktop platform, contact information maintained by a third party application via the at least one interface, and wherein the displaying step further comprises included the third party contact information with the contact information displayed in the window.

7. The desktop platform of claim 6, wherein execution of the one or more sequences of instructions by the one or more processors causes the one or more processors to perform a contact import step of importing, in the desktop platform, contact information maintained by a third party application maintained on the desktop platform, and wherein the displaying step further comprises included the third party contact information with the contact information displayed in the window.

8. The desktop platform of claim 1, wherein some of the third party contacts are not associated with the network platform, and wherein execution of the one or more sequences of instructions by the one or more processors causes the one or more processors to perform an invitation step of sending, in the desktop platform, and invitation to a third party contact to join the network platform.

9. The desktop platform of claim 1, wherein execution of the one or more sequences of instructions by the one or more processors causes the one or more processors to perform a communication step of sending, in the desktop platform, a message to a selected contact using a communication program associated with the selected contact in the contact information.

10. The desktop platform of claim 9, wherein the communication step comprises sending the message using a default communication program.

11. The desktop platform of claim 9, wherein the communication step further comprises displaying information associated with the communication applications and receiving a selection indicting a selected communication application, and wherein the message is sent using the selected communication application.

12. The desktop platform of claim 11, wherein the communication application is an SMS application.

13. The desktop platform of claim 11, wherein the communication application is an instant message application.

14. The desktop platform of claim 11, wherein the communication application is an email application.

15. The desktop platform of claim 11, wherein the communication application is a Voice Over Internet Protocol (VOIP) application.

16. The desktop platform of claim 11, wherein the communication application is a blog application.

17. The desktop platform of claim 11, wherein the communication application is a chat application.

18. The desktop platform of claim 11, wherein the communication application is a videoconferencing application.

19. The desktop platform of claim 11, wherein the communication application is a teleconferencing application.

20. The desktop platform of claim 1, wherein execution of the one or more sequences of instructions by the one or more processors causes the one or more processors to perform a message indication step of receiving, in the desktop platform, a message for the user and displaying a message pending indicator in the window.

21. The desktop platform of claim 20, wherein the message pending indicator is a toaster pop-up indicator.

22. The desktop platform of claim 1, wherein the desktop platform is implemented on a mobile device.

23. A system, comprising:
a network platform for maintaining a plurality of network-enabled applications and contact information for a plurality of users, the network platform comprising a plurality of communication channels to a respective plurality of wireless network carriers, each of the wireless network carriers having a plurality of users;
at least one processor;
at least one interface having access to the internet; and
at least one computer readable medium carrying one or more sequences of instructions for integrating the plurality of network-enabled application with the platform and billing a user for the use of the network-enabled application, wherein execution of the one or more sequences of instructions by the one or more processors causes the one or more processors to perform:
a billing event detection step of detecting, in the network platform, a billing event generated by one of the plurality of network-enabled application, the billing event containing an identification code corresponding to the user,
a billing validation step of validating, in the network platform, the billing event generated by the network-enabled application by determining if the billing event is in accordance with a predetermined pricing structure corresponding to the network-enabled application,
a billing message step of sending, in the case that the billing event is determined to be valid in the billing validation step, a billing message from the platform to an external billing mechanism, the billing message containing a billing amount which the external billing mechanism bills to the user, and
a billing event discard step of discarding, in the case that the billing event is determined to be invalid in the billing validation step, the billing event from the network platform; and
a desktop platform configured to interface with the network platform, the desktop platform comprising:
a display;
at least one processor;
at least one interface having access to the internet; and
at least one computer readable medium carrying one or more sequences of instructions for interfacing the desktop platform with the network platform, wherein execution of the one or more sequences of instructions by the one or more processors causes the one or more processors to perform:
a contact download step of downloading, in the desktop platform, the contact information maintained by the network platform via the at least one interface;
a displaying step of displaying, in the desktop platform, a window that includes the contact information on the display;
a selection step of receiving, in the desktop platform, a selection of an application or content residing on the desktop platform; and
a sharing step of sending, in the desktop platform, the selected application or content to a contact included in the contact information via the at least one interface, wherein the sharing step is achieved by dragging the selected application or content into the window and dropping the application or content onto a contact include in the contact information.

24. The system of claim 23, wherein execution of the one or more sequences of instructions by the one or more processors causes the one or more processors to perform an application download step of downloading, in the desktop platform, one or more of the plurality of network-enabled applications to the desktop platform via the at least one interface.

25. The system of claim 24, wherein the external billing mechanism is one of the wireless network carriers that corresponds to the user, and wherein execution of the one or more sequences of instructions by the one or more processors further causes the one or more processors to perform:
a selection receipt step of receiving, in the network platform, a selection indication from the user via the desktop platform, the selection indication including an application identifier corresponding to the network-enabled application, and
a subscription step of subscribing the user to the network-enabled application by entering information related to the user into a database in the platform in association with the network-enabled application, wherein, upon subscription of the user to the network-enabled application, the user is enabled to utilize the services of the network-enabled application.

26. The system of claim 25, wherein, upon subscription of the user to the network-enabled application, the user is enabled to download the network-enabled application to the desktop platform.

27. The system of claim 26, wherein execution of the one or more sequences of instructions by the one or more processors further causes the one or more processors to perform:
a pricing display step of displaying, in the network platform, in response to the selection indication from the user in the selection step, a pricing structure on a pricing webpage operated by the network platform, the pricing structure corresponding to the network-enabled application; and
a confirmation step of receiving a confirmation indication from the user in response to the display of the pricing structure in the pricing display step, the confirmation indication instructing the platform to proceed to subscribe the user to the network-enabled application.
